(19) United States
(12) Patent Application Publication
(10) Pub. No.: US 2022/0207980 A1
(43) Pub. Date: Jun. 30, 2022

(54) INFERRING AND REPORTING WELL-BEING STATUS FROM SENSED UTILITY USAGE

(71) Applicant: carepenguin, Inc., Lafayette, CO (US)

(72) Inventors: Todd VERNON, Lafayette, CO (US); Marlo VERNON, Lafayette, CO (US); Nicholas ISAACS, Boulder, CO (US)

(21) Appl. No.: 17/390,740

(22) Filed: Jul. 30, 2021

Related U.S. Application Data
(60) Provisional application No. 63/132,653, filed on Dec. 31, 2020.

(51) Int. Cl. G08B 21/04; G06K 9/62; G06N 5/04

(52) U.S. Cl. CPC G08B 21/0484; G06N 5/04; G06K 9/627

(57) ABSTRACT

The present invention involves individualized, non-intrusive monitoring of a person to determine health, well-being and ability to live independently or with minimal and tailored assistance. One or more sensors collect data corresponding to usage of utilities in a person's residence. This sensor data is processed in near-real time to compare present usage patterns to past usage or other standards. Algorithms identify when usage data patterns indicate cause for concern or that attention or intervention is required. Additionally, mechanisms are provided that allow interested persons to check status or receive alerts concerning the monitored person's health and well-being status and when attention or intervention is advantageous.

### CROSS-REFERENCE TO RELATED APPLICATIONS

The present application claims priority under 35 U.S.C. §119(e) of U.S. Patent Application Ser. No. 63/132,653, filed Dec. 31, 2020, the disclosures of which are incorporated by reference herein.

### BACKGROUND OF THE INVENTION

### Field of the Invention

The invention pertains to sensing devices and processing of data from sensing devices. More particularly, the invention pertains to inferring presence and activities of humans from data corresponding to sensed usage of utilities.

### Description of the Related Art

A challenge has been identified in supporting people who are at-risk but desire to live independently. This includes a wide segment of population, for example people who are aging, recovering from medical procedures, are experiencing physical or cognitive challenges such as dementia or Alzheimer's disease, or are otherwise limited in movement, or are facing a higher risk of injury or are at risk for being unable to maintain daily activity and live independently. It is often desirable that these people live with as much autonomy as possible yet have ready and fast access to help when needed. Detecting the need for help is a particular challenge.

A 2018 American Association of Retired Persons (AARP) National Survey showed that 76% of senior citizens want to stay in their current residence as they age. Data shows that 80% of Americans aged 65 live in their own homes, yet by age 95 only 54% live independently.

In addition, often other interested people wish to monitor the health of these individuals, such as friends, family, loved ones, caregivers, or medical professionals. It may not be possible or desirable for these interested people to be geographically nearby to the at-risk person, yet they have a need to be able to check the status of the person and be alerted if assistance is required. Remote monitoring of health and well-being is needed.

The need for technology to help elders age in place is an ever-growing opportunity. The future of longevity is a booming market. The elderly population is growing rapidly and is projected to nearly double from 52 million in 2018 to 90 million by 2050. AARP and Oxford Economics sized the United States Aging Economy at S7.6 trillion annually. Terms such as “Age Tech” and “Longevity economy” have been coined to describe this interesting area of human-centered technology.

However, existing technology solutions have drawbacks and limitations that prevent them from being an adequate, affordable, or complete solution to this challenge.

Although modern ubiquitous communication devices are available, a person may be incapacitated or unconscious and unable to use a device to request help. Conversely, a person not answering a phone call or message may not indicate a need for assistance—the person may simply be ignoring calls or have the phone “off the hook” desiring silence or privacy. Thus, it may be difficult for an interested person to assess health and well-being using conventional communication methods and devices.

Traditional remote monitoring schemes using cameras, microphones or sensors to share images or sounds from the home of the monitored person are ineffective for several reasons. First, they may be intrusive and invasive to the privacy of the person. Also, such devices have limited range and are not able to monitor every part of a home, especially if it is larger or has many rooms.

In addition, these devices must be added to the residence, connected, maintained, and monitored. They are not part of daily activity, so may be awkward, unsightly, and fall into neglect or malfunction. In some cases, a person being monitored may tamper with, disable, or intentionally avoid these devices.

The challenge of determining if a person is able to live independently and is maintaining healthful daily habits and functions has inspired much research. This has yielded several measures and assessment techniques to determine health status of a person. One particularly useful set of criteria is the Activities of Daily Life (ADL) which are a standard to test independent living capacity of an individual. ADL is attributed to Sidney Katz and has spawned a wide variety of research and publications since their introduction in 1983.

“The activities of daily living (ADLs) are both essential and routine aspects of self-care. The six essential ADLs includes the ability to be able to independently eat, dress, walk or transfer from one position to another, bathe, and toilet, and maintaining bowel and bladder continence. Independent adults generally may manage activities of daily living so that they can successfully live without assistance from outside caregivers or significant others.” [From Edemekong PF, Bomgaars DL, Levy SB. Activities of Daily Living (ADLs). In: StatPearls. StatPearls Publishing, Treasure Island (FL); 2019.]

Although ADLs provide a standard set of activities and criteria by which a person's ability to live independently may be determined, they have limitations in that the standard they provide is generic and not tailored to the habits or past patterns of the person being monitored.

One approach to monitoring an at-risk person is to have a human caregiver, friend, or family member live in the same residence or look in on them periodically. Similarly, residential care facilities provide a staff of proximate caregivers. This has several limitations in that it is not continuous and often not convenient and is often costly. In addition, an outside visitor may be seen as intrusive and disruptive to the habits for the person being monitored, particularly if the visitor is not recognized or familiar to the person.

It is also desirable to have the ability to monitor the health and independence of people in a manner that involves little or no contact with other humans, due to risk of contagious diseases being transmitted. The risk is especially high if a person who visits is also visiting other people. Particularly in times of pandemic that mandate isolation or quarantine to reduce contact and potential contagion, visits by family members or caregivers may be very risky for the person being monitored. People facing challenges in living independently are also often at risk from contagious disease—such as the sick, elderly, or recovering.

A new and unique combination of sensing utility usage, processing and storage of usage data, pattern recognition and comparison, and status reporting and alerting, has been discovered.

The following publications detail these challenges, and are incorporated by reference herein in their entireties:

Katz, S. (1983). “Assessing self-maintenance: Activities of daily living, mobility, and instrumental activities of daily living.” Journal of the American Geriatrics Society, 31(12), 721-727. https://doi.org/10.1111/j.1532-5415.1983.tb03391.x

Stephen Katz, “Busy Bodies: Activity, aging, and the management of everyday life.” Journal of Aging Studies, Volume 14, Issue 2, June 2000, Pages 135-152. https://www.sciencedirect.com/science/article/abs/pii/S0890406500800080#!

Daniel López Gómez, “Little arrangements that matter. Rethinking autonomy-enabling innovations for later life” in Technological Forecasting and Social Change, Volume 93, April 2015, Pages 91-101 https://www.sciencedirect.com/science/article/abs/pii/S0040162514000791

### SUMMARY OF THE INVENTION

One or more sensors collect data corresponding to usage of utilities in a person's residence. This sensor data is processed in near-real time, comparing present usage patterns to observed past usage patterns or to other pre-determined standards. Algorithms identify when comparison of usage data over time indicates cause for concern or that attention or intervention is required. Additionally, mechanisms are provided that allow interested persons to check status or receive alerts concerning the monitored person's health and well-being status. This provides or augments individualized monitoring of health, well-being and ability to live independently, or with minimal and tailored assistance.

The present invention, in one form, relates to inferring well-being status and activities of a human from sensed usage of residential utilities, in near real-time.

The present invention, in another form, is a method for creating a reference pattern corresponding to a normal pattern of utility usage for an individual, by observation of the individual's patterns and habits over time or by defining rules.

Further aspects of the present invention involve a novel approach to detection of flow of hot water utility in a residential plumbing network piping, without need to cut or modify the existing network, and by sensing temperature at an outer surface of a selected pipe.

Another aspect of the invention relates to a machine-readable program storage device for storing encoded instructions for a method of comparing present pattern of utility usage to a reference to determine well-being status, according to the foregoing method.

Another aspect of the invention is mechanisms for providing status and notifications concerning the well-being of a person, including status displays, alert mechanisms, and an application and associated machine-readable instructions suitable for a computing device.

Further aspects of the invention are illustrated in embodiments where utility utilization involves the subject using hot water and monitoring the hot water demand and usage to determine human activity, as with other embodiments using other utility measures. Embodiments of the invention use an algorithm that uses high attack temp to determine the start of event. Further processing uses a slope calculation to determine attack (i.e. positive rate of change) and decay (i.e. negative rate of change) as indicators to detect utility usage and usage events. For example, without limitation, the processing may use an attack of greater that a 5 degree rise in temperature over two points 120 seconds apart to determine the “attack” or start of a usage event. Within the algorithm, detecting the slope passing back through zero rate, after a positive attack event has been detected, is used to determine a “tentative” end event. Once observing a tentative end event, the algorithm analyses by looking at previous samples until the max temperature is found in a recent sample series, creating a probable “end event”. Thus, creating a “usage” event based on attack event and probable end event is calculated. Then the duration of the event may be used to determine an “event”, and further using duration events, periods in a day may be marked that make up a normal pattern of water usage.

Additional embodiments of the invention involve using a utility installation in a residence in combination with a utility flow detection mechanism, as a signal communication network, (further using the communication network to detect well-being status of a person). Wherein a person creating a demand for said utility by appropriate controls (light switch, water faucet, toilet flush) creates a detectable signal that is sensed at a remote place in the residential utility installation. The utility being sensed may be an electric supply and the conductive flow of electricity provides signal communication, alternatively the utility being sensed is water supply and the fluidic flow of water provides signal communication. When the utility being sensed is hot water supply, the fluidic flow of water at elevated temperature may provide signal communication. This allows using a particular utility installation in a residence, in combination with a sensing device, to create a new sensing device with extended range and new capability that extends the range to all or a selected portion of the utility installation in the residence. For example, if the utility being sensed is electric supply then the conductive flow of electricity may provide signal communication to create a sensor with a range mapping to the selected portion of the residential electrical wiring installation, or if the utility being sensed is water supply then the fluidic flow of water may provide signal communication with a range extending to the selected portion of residential plumbing installation. Further, if the utility being sensed is hot water supply then the fluidic flow of water at elevated temperature may provide signal communication to extend sensor range.

Another embodiment of the present invention involves a system for determining health and well-being of a human person. At least one sensor is used for detecting usage of utilities. A timer device provides interval measurement, rate measurement, and calendar time. A storage device is for storing sensor data and usage patterns. A processing device is in signal communication with sensors, storage, and timer, and is configured to compare in near real-time, sensed present utility usage patterns over time to a reference pattern, and to alert when an anomaly is detected. Status reporting and alerting mechanisms to provide information to interested parties. The sensor may be for detecting flow (usage) of hot water, and may be located at exit of residential hot water heating device. In the case of a apartment complex or assisted living facility, the sensor may be located at point where a shared utility network becomes non-shared. Water flow may be detected by sensing rate of change of temperature of hot water pipe (no plumbing modification needed). The rate of change of 5 degrees F. over 120 seconds may be taken as a threshold indicating initiation of usage. Usage events may be determined based on detecting patterns or features in the stored history of sensed data and correlating time of features. The start of an event or attack may be determined from positive rate of change of temperature and end of event from decay or negative rate of change of temperature (slope). The usage patterns may be based on detecting one or more usage events, events comprising one or more of: a detection of time of positive rate of temperature change corresponding to initiation of flow of hot water; measuring a time duration; subsequent detection of time of a negative rate of temperature change corresponding to ceasing flow of hot water; a detection of cessation time based on negative rate of temperature change of a pipe corresponding to cessation of flow of hot water; searching stored data immediately prior in time to the cessation detection for positive rate of temperature change corresponding to start of usage; and determining a usage event based on the start time, cessation time, and time duration between events.

Further embodiments of the invention involve a method for detecting human activity. Installing, at a preferred location within a residential utility delivery network, a sensor configured to detect flow of the utility through the network. Optionally installing additional flow sensors at other locations within said residential utility delivery network or in other utility network within residence (i.e. another utility gas vs electric). Sensing flow of utility(ies). Noting time and duration of flow, and optionally volume of flow. Comparing flow times and duration patterns to a reference pattern. Applying pattern matching logic to determine if present activity differs from a reference pattern. The flow patterns may be used to infer human activity of a person in the residence and using the utility network(s). Additionally, the flow patterns and comparisons may be used to infer health and well-being status of person in residence. Where the utility is water, the elevated temperature may be used wherein the delivery network is the hot water plumbing system in the residence. The reference pattern may be obtained from storage of past sensed flow of utility through the utility network. The reference pattern may be based on rules defined and stored, and logic may be used to determine difference from a reference pattern based on past sensed flow, and additionally to determine if a person living in the residence and using the utility in said network is in need of attention or assistance. Further steps may involve maintaining in a memory, a well-bring status of person living in residence; providing status upon request to devices and applications; pushing alerts to devices and applications when the status meets configurable criteria for desired notification.

Another embodiment of the invention involves a method for detecting flow of hot water in a pipe. A temperature sensor may be installed adjacent to pipe positioned and configured to measure the temperature of the outer surface of the pipe. The measured sensor may be sampled at intervals controlled by a timing device. The time rate of change of the temperature of outer pipe surface may be calculated from samples and times. Flow may be inferred within pipe when time rate of change of outer surface temperature over a predetermined interval, exceeds a predetermined threshold value, for example without limitation, an increase of at least 5 degrees F. within 20 seconds. Cessation of flow within in the pipe may additionally be inferred when time rate of change of outer surface temperature is less than zero and flow has been previously detected.

Further embodiments of the invention provide a method for determining usage of a utility based on detecting usage events. An event start time may be found based on detecting a pattern in a stored series of flow measurements. An event end time may alternatively based on detecting a pattern in a stored series of flow measurements that are obtained after the event start time. An event duration time may be calculated as the interval between end time and start time, and the usage event may be stored in a reference memory including start time and duration.

Other embodiments of the invention involve a method of creating a reference pattern of usage of a utility. The flow status of a utility may be detected at intervals during a 24 hour period, and may be processed to detect usage events. The usage events may be stored in a database configured to allow searching for events, using a search criteria of events that were started within any sub-interval of the 24 hour period (i.e. event count between 5 am and noon).

Further embodiments of the invention involve a method of determining anomalous behavior by a person living in a residence, for example without limitation recalling from a database/memory, the number (and optionally duration) of utility flow events in a time interval corresponding to a continuous part of a day (e.g. morning) in the present day. Further recalling from database/memory, the number (and optionally duration) of flow events in a time interval corresponding to the same part of day in a reference pattern may be included. By comparing the number (and optionally the duration) of present-day flow events with the number of reference-day flow events anomalous behavior may be determined. When a difference is detected, one may further apply the method steps to a longer interval (e.g., extending further back in time, mid-day+morning).

Still another embodiment of the invention involves a method for creating a reference day pattern of utility usage to be used in detecting the well-being status of a person living in a residence. One may start by determining the type of reference day to be created (e.g. Tuesday, Weekday, Weekend), then recalling from memory, stored usage of utility usage of a particular type of utility in the residence, on a plurality of days corresponding to the type of reference day (e.g. past 4 Tuesdays). By detecting, in recalled past usage data, usage that occurred in a majority of the plurality of recalled days well-being status may or may not be inferred.

Another further embodiment of the invention involves a method of creating a reference pattern of usage of a utility, comprising entering rules in structured and constrained human readable form. By defining a form of a rule structure with multiple fields which define the consequents and antecedents of the rule, a reference pattern of usage may be derived. For example, defining, for each field, a limited number of possible values which may be selected for the field, optionally providing a tool to create or edit the rule by offering a user selection of the possible values for each field, optionally providing a consistency check to detect illogical or invalid combinations of value selections, may be employed. An inference engine may then be designed and used to apply rules against observations of utility usage events.

Alternative embodiments of the invention involve a method of creating a reference pattern of usage of a utility. The flow status of a utility may be automatically detected at a plurality of spaced intervals during a 24 hour period and the flow status observations may be processed to detect usage events. Further, the usage event data from a plurality of observations may be processed to create one or more rules describing the pattern of usage, and optionally a mechanism for a human to read and/or edit the rules created may be provided.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 is a schematic depiction of components arranged in accordance with embodiments of the present invention.

FIG. 2 is a depiction of high-level components and functions essential to implementing embodiments of the present invention.

FIG. 3A and FIG. 3B are schematic depictions of prior art methods and systems for signaling and remote sensing that will be helpful in illustrating particular features and advantages of the present invention.

FIG. 4 depicts an embodiment according to the present invention where a utility network is used for signaling or remote sensing.

FIG. 5 depicts a utility network system in which embodiments of the present invention may be utilized.

FIG. 6 schematically depicts another utility network system in which embodiments of the present invention may be utilized.

FIG. 7 illustrates the correlation between human activity and usage of utilities in a residence that forms the basis for embodiments of the present invention.

FIG. 8 schematically depicts applying embodiments of the present invention to a multi-unit dwelling utility network with a shared hot water heater.

FIG. 9 schematically depicts applying embodiments of the present invention to a utility network in a multi-unit dwelling where each dwelling has a dedicated hot water heater.

FIG. 10 depicts a detailed embodiment of components and devices arranged to implement an embodiment according to the present invention.

FIG. 11 shows a detailed depiction of another embodiment according to descriptions of the present invention.

FIG. 12 is a pictorial description of a data structure and hierarchy that may be used in embodiments of the present invention.

FIG. 13 illustrates flow of data, and process steps, and storage, in accordance with embodiments implementing the present invention.

FIGS. 14 and 15 schematically depict sensor data and processing methods to detect events in accordance with embodiments of the present invention.

FIGS. 16A and 16B are flow charts illustrating detection of an event according to an embodiment of the present invention.

FIG. 17 depicts a schematic representation according to the present invention, for pattern matching to determine if a present usage pattern matches a reference usage pattern.

FIG. 18 depicts a schematic representation according to the present invention, for using enhanced awareness of the situation to determine if present usage patterns are anomalous.

FIGS. 19A and 19B depict an embodiment implementing a rule-based scheme to define a reference pattern for comparing present usage data to a defined reference and defining consequent actions.

FIG. 20 schematically illustrates logic, inputs, and outputs that create a notification system in accord with an embodiment of the present invention.

FIGS. 21A, 21B, and 21C provide schematic depictions of data displays employed to show a user the well-being status in embodiments.

FIGS. 22A and 22B diagrammatically depict a state machine model implemented to track well-being and alert status in embodiments of the invention.

FIG. 23 is a schematic diagrammatic view of a network system in which embodiments of the present invention may be utilized.

FIG. 24 is a block diagram of a computing system (either a server or client, or both, as appropriate), with optional input devices (e.g., keyboard, mouse, touch screen, etc.) and output devices, hardware, network connections, input and output capable devices, one or more processors, and memory/storage for data and modules, etc. which may be utilized in conjunction with embodiments of the present invention.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. It should be appreciated that many of the screen shots and display examples are shown as monochromatic for illustration, yet in embodiments the full graphical display capabilities of the display device would be utilized, for example employing colored elements, and contrasting or changing colors to indicate information. The exemplification set out herein illustrates an embodiment of the invention, in one form, and such exemplifications are not to be construed as limiting the scope of the invention in any manner

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings. While technology should continue to develop and many of the elements of the embodiments disclosed may be replaced by improved and enhanced items, the teaching of the present invention is inherent in the disclosure of the elements used in embodiments using technology available at the time of this disclosure.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general-purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

Further, the manipulations performed are often referred to in terms, such as comparing or adding, commonly associated with mental operations performed by a human operator. No such capability of a human operator is necessary, or desirable in most cases, in any of the operations described herein which form part of embodiments of the present invention; the operations are machine operations. The operations of these algorithms are deterministic with the accuracy and complexity management that are not obtainable by human mental steps even though the language used to describe them in the detailed description below at some time references a mental step.

This requirement for machine implementation for the practical application of the algorithms is understood by those persons of skill in this art as not a duplication of human thought, rather as significantly more than such duplication. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general-purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general-purpose machines may be used with programs written in accordance with the teachings herein, or it may prove more convenient to construct more specialized apparatus to perform the required method steps. The required structure for a variety of these machines will appear from the description below.

In the following description, several terms which are used frequently have specialized meanings in the present context. The term “object” relates to a set of computer instructions and associated data which may be activated directly or indirectly by the user. The terms “windowing environment”, “running in windows”, and “object-oriented operating system” are used to denote a computer user interface in which information is manipulated and displayed on a video display such as within bounded regions on a raster scanned, liquid crystal matrix, or plasma based video display (or any similar type video display that may be developed). The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world-wide network of computers, namely the “World Wide Web” or simply the “Web”. Examples of Browsers compatible with one or more embodiments of the present invention include the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details such operations in terms of a graphic user interface of a Browser, one or more embodiments of the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method). Similarly, JavaScript Object Notation (JSON) may be used to convert between data file formats.

The terms “personal digital assistant”, or “PDA”, or smartphone as defined above, means any handheld, mobile device that combines two or more of computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g., a handheld device, and a second device, e.g., a desktop computer or a computer network, either via wires or wirelessly. Synchronization ensures that the data on both devices are identical (at least at the time of synchronization).

Data may also be synchronized between computer systems and telephony systems. Such systems are known and include keypad-based data entry over a telephone line, voice recognition over a telephone line, and voice over internet protocol (“VoIP”). In this way, computer systems may recognize callers by associating particular numbers with known identities. More sophisticated call center software systems integrate computer information processing and telephony exchanges. Such systems initially were based on fixed wired telephony connections, but such systems have migrated to wireless technology.

In wireless wide area networks, communication primarily occurs through the transmission of radio signals over analog, digital cellular, or personal communications service (“PCS”) networks. Signals may also be transmitted through encoding and modulation of microwaves and other electromagnetic waves. Much wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), Fifth Generation (“5G”), personal digital cellular (“PDC”), or through packet-data technology over analog systems such as cellular digital packet data (“CDPD”) used on the Advance Mobile Phone Service (“AMPS”).

“Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Washington), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

The term “Wi-Fi” or “WiFi” refers herein to protocols for providing wireless local area networking, typically used to provide multiple wireless devices with interconnection to each other and internet access through a wireless access point (WAP). WiFi protocols are based on a family of standards from the Institute of Electrical and Electronic Engineers (IEEE) identified as standard numbers in the 802.11 family.

In the following specification, the term “social network” may be used to refer to a multiple user computer software system that allows for relationships among and between users (individuals or members) and content accessible by the system. Generally, a social network is defined by the relationships among groups of individuals and may include relationships ranging from casual acquaintances to close familial bonds. In addition, members may be other entities that may be linked with individuals. The logical structure of a social network may be represented using a graph structure. Each node of the graph may correspond to a member of the social network, or content assessable by the social network. Edges connecting two nodes represent a relationship between two individuals. In addition, the degree of separation between any two nodes is defined as the minimum number of hops required to traverse the graph from one node to the other. A degree of separation between two members is a measure of relatedness between the two members.

Social networks may comprise any of a variety of suitable arrangements. An entity or member of a social network may have a profile and that profile may represent the member in the social network. The social network may facilitate interaction between member profiles and allow associations or relationships between member profiles. Associations between member profiles may be one or more of a variety of types, such as friend, co-worker, family member, business associate, common-interest association, and common-geography association. Associations may also include intermediary relationships, such as friend of a friend, and degree of separation relationships, such as three degrees away. Associations between member profiles may be reciprocal associations. For example, a first member may invite another member to become associated with the first member and the other member may accept or reject the invitation. A member may also categorize or weigh the association with other member profiles, such as, for example, by assigning a level to the association. For example, for a friendship-type association, the member may assign a level, such as acquaintance, friend, good friend, or best friend, to the associations between the member's profile and other member profiles.

Each profile within a social network may contain entries, and each entry may comprise information associated with a profile. Examples of entries for a person profile may comprise contact information such as an email addresses, mailing address, instant messaging (or IM) name, or phone number; personal information such as relationship status, birth date, age, children, ethnicity, religion, political view, sense of humor, sexual orientation, fashion preferences, smoking habits, drinking habits, pets, hometown location, passions, sports, activities, favorite books, music, TV, or movie preferences, favorite cuisines; professional information such as skills, career, or job description; photographs of a person or other graphics associated with an entity; or any other information or documents describing, identifying, or otherwise associated with a profile. Entries for a business profile may comprise industry information such as market sector, customer base, location, or supplier information; financial information such as net profits, net worth, number of employees, stock performance; or other types of information and documents associated with the business profile.

A member profile may also contain rating information associated with the member. For example, the member may be rated or scored by other members of the social network in specific categories, such as humor, intelligence, fashion, trustworthiness, sexiness, and coolness. A member's category ratings may be contained in the member's profile. In one embodiment of the social network, a member may have fans. Fans may be other members who have indicated that they are “fans” of the member. Rating information may also include the number of fans of a member and identifiers of the fans. Rating information may also include the rate at which a member accumulated ratings or fans and how recently the member has been rated or acquired fans.

A member profile may also contain social network activity data associated with the member. Membership information may include information about a member's login patterns to the social network, such as the frequency that the member logs in to the social network and the member's most recent login to the social network. Membership information may also include information about the rate and frequency that a member profile gains associations to other member profiles. In a social network that comprises advertising or sponsorship, a member profile may contain consumer information. Consumer information may include the frequency, patterns, types, or number of purchases the member makes, or information about which advertisers or sponsors the member has accessed, patronized, or used.

A member profile may comprise data stored in memory. The profile, in addition to comprising data about the member, may also comprise data relating to others. For example, a member profile may contain an identification of associations or virtual links with other member profiles. In one embodiment, a member's social network profile may comprise a hyperlink associated with another member's profile. In one such association, the other member's profile may contain a reciprocal hyperlink associated with the first member's profile. A member's profile may also contain information excerpted from another associated member's profile, such as a thumbnail image of the associated member, his or her age, marital status, and location, as well as an indication of the number of members with which the associated member is associated. In one embodiment, a member's profile may comprise a list of other social network members' profiles with which the member wishes to be associated.

An association may be designated manually or automatically. For example, a member may designate associated members manually by selecting other profiles and indicating an association that may be recorded in the member's profile. According to one embodiment, associations may be established by an invitation and an acceptance of the invitation. For example, a first user may send an invitation to a second user inviting the second user to form an association with the first user. The second user may accept or reject the invitation. According to one embodiment, if the second user rejects the invitation, a one-way association may be formed between the first user and the second user. According to another embodiment, if the second user rejects the association, no association may be formed between the two users. Also, an association between two profiles may comprise an association automatically generated in response to a predetermined number of common entries, aspects, or elements in the two members' profiles. In one embodiment, a member profile may be associated with all of the other member profiles comprising a predetermined number or percentage of common entries, such as interests, hobbies, likes, dislikes, employers and/or habits. Associations designated manually by members of the social network, or associations designated automatically based on data input by one or more members of the social network, may be referred to as user established associations.

Examples of social networks include, but are not limited to, Facebook, Twitter, Myspace, LinkedIn, Google plus, Google circles, Instagram, Tinder, TikTok, and other systems. Social networks, as any area of internet-based business, are continually being created, deleted, and modified to appeal to certain users or fulfill demand, so no list of social networks or features remains complete for any time and the above list is purely exemplary. The exact terminology of certain features, such as associations, fans, profiles, etc. may vary from social network to social network, although there are several functional features that are common to the various terms. Thus, a particular social network may have more of less of the common features described above. In terms of the following disclosure, generally the use of the term “social network” encompasses a system that includes one or more of the foregoing features or their equivalents.

As used herein, the term “social distancing” refers to a set of practices and procedures intended to allow persons to have limited and constrained participation in social activity while reducing the risk of spreading contagious disease from one person to another. This is put into effect where disease-causing pathogens may be spread from person to person via airborne particles or aerosols, typically to reduce spread of disease in time of pandemic. Social distancing includes maintaining a specified minimum distance or spacing between persons, e.g. maintaining at least 6 feet of separation. Social distancing may also include other measures with a similar objective, such as limiting the number of persons in an indoor space simultaneously or requiring all persons to wear a mask or facial shield covering mouth and nose when in the presence of others. Social distancing practices are often combined with other practices such as avoiding touching one's face, frequent and thorough handwashing, use of sanitizing chemicals, or wearing protective gear such as gloves, and using virtual services for meetings where possible, all with the objective of preventing spread of pathogens and preventing pathogen-caused disease spread by inter-personal contact and by sharing air that may contain pathogens.

As used herein, the term “Utility” refers a consumable commodity provided to a location via a specifically configured delivery network, supplied in amounts and at rates to meet timely demand by consumers at that location. Thus, a utility is often said to “flow” to the location and the commodity provided is “used” at the location. The location is often a dwelling, residence, business, or factory. Examples of a utility service are, without limitation: electricity, water, hot water, natural gas, steam, propane, compressed air, internet service, and cable television.

As used herein, the term “well-being” is a noun that relates to the condition of a person being monitored, also termed “well-being status.” A person's well-being status describes his or her overall state of health and ability to maintain independence and successfully undertake normal daily activities.

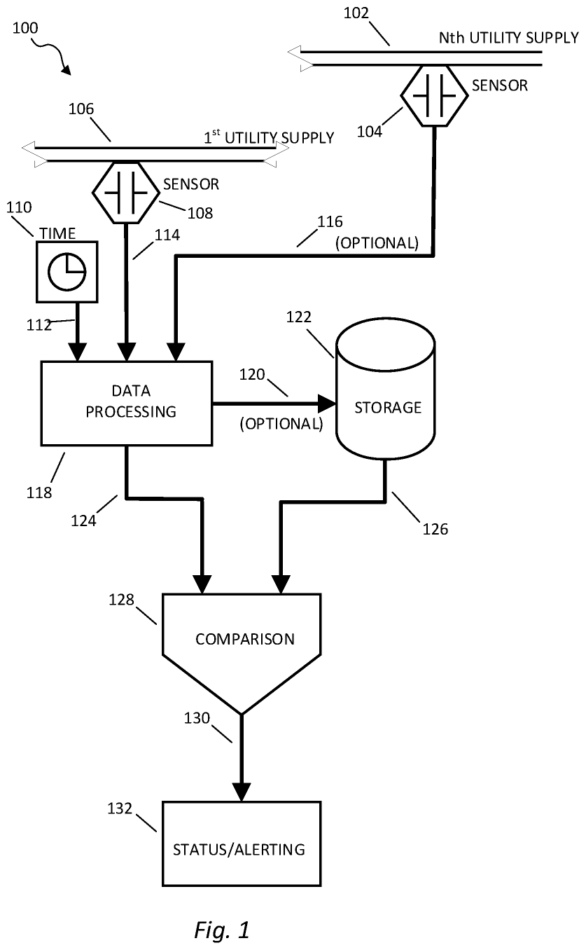

FIG. 1 is a schematic depiction of an arrangement 100 of components in accordance with embodiments of the present invention. Utility supply 106 is a conduit that supplies a utility to a residence or part of a residence. The utility may be any of the various utility services typically provided to a residence, such as hot water or electricity. Sensor 108 senses flow of utility through supply 106. It should be appreciated that supply 106 provides unidirectional flow of the utility service. It should also be appreciated that sensor 108 is selected to sense the utility item flowing through supply 106 and those skilled in the art will recognize that a sensor must be selected to correspond to the type of utility being sensed, sensor location, and desired accuracy. For example, different sensing technology is required to sense flow of electricity than for sensing flow of water, and in embodiments, many sensor types and sensing technologies are employed, all in accordance with embodiments of the present invention.

Although various sensors and sensing techniques are known in the art, embodiments of the present invention benefit from selection of certain sensors for specific types of utility, and the sensor selection and advantages will become apparent from subsequent descriptions herein. In various embodiments, the invention relies on data from a selected sensor, but nothing in the invention requires a specific sensor, or type of sensing equipment, or device.

Similarly in FIG. 1, optional sensor 104 senses unidirectional flow of Utility Supply 102. Utility supply 102 may be of the same type of utility as supply 106 or of a different type. Optional sensor 104 is shown to illustrate an alternate embodiment of the invention. It should be appreciated that the invention described herein may be implemented with a single sensor 108 sensing flow of a single utility 106, or with one or multiple additional sensors such as sensor 104 sensing flow of utility supply 102, and that additional sensors such as sensor 104 may sense the same type of utility or another type, and that each sensor is selected to sense the type of utility flow as in Utility Supply 102.

Although a single additional sensor 104 is shown, it is to be understood that no limit is implied on the number or type of sensors used, in fact the opposite is true—the point is to illustrate that embodiments of the present invention may incorporate any number and type of sensors attached to sense flow of any number and type of utility supplies.

Still referring to FIG. 1, data processor 118 collects and applies processing algorithms to sensor data. Data from sensor 108 is collected through connector 114. In embodiments where Sensor 104 is present, Data processor 118 collects data from sensor 104 through connector 116.

Those familiar with the art will appreciate that although data connectors 114 and 116 are shown as transmitting data to data processor 118, sensor 108 and sensor 104 typically are not stand alone but require support electronics (not shown) from data processor 118. This support may include power, excitation, bias, sampling, or validity checking.

In addition, time base 110 provides timing information through connection 112 to data processor 118. Time base 110 serves to provide two functions. First, time base 110 provides calendar and time-of-day information to use in tagging data collected from sensor 108 and in embodiments where present, tagging other sensors such as Sensor 104. Second, time base 110 provides clocking information to support data processor 118 in measuring intervals and rates of change over intervals.

Data processor 118, in some embodiments, provides detection of utility usage events. A utility usage event is defined herein as a period of utility flow marked by an initial beginning or “attack” phase, a duration of flow phase, and a “decay” or cessation of flow phase, matched with a time tag to indicate where in calendar time the event occurred. These elements are further described later.

Storage 122 provides a reference sequence. In some embodiments, this is a sequence of utility usage events via communication path 126 to comparison 128. Comparison 128 obtains a present usage data stream through link 124 from data processor 118. Comparison 128 compares the present and reference data sequence to determine when attention or further attention is required.

Note that in some embodiments, the reference sequence provided by storage 122 is based on a pre-determined sequence. In other embodiments of the present invention, the system learns or updates reference patterns in storage 122 using present data, provided from data processor 118 via link 120.

Comparison 128 uses pattern matching techniques to determine if reference pattern from storage 122 matches present behavior from data processor 118. The result is communicated via link 130 to status/ alerting mechanism 132.

It should be appreciated the processing blocks shown here are described as implementing various functions but in embodiments the functions may be distributed across many processors and spread far apart using network connections. That is, the schematic depictions show operations, one possible order of operations, and data flow but are not representative of physical or geographical locations where the operations occur.

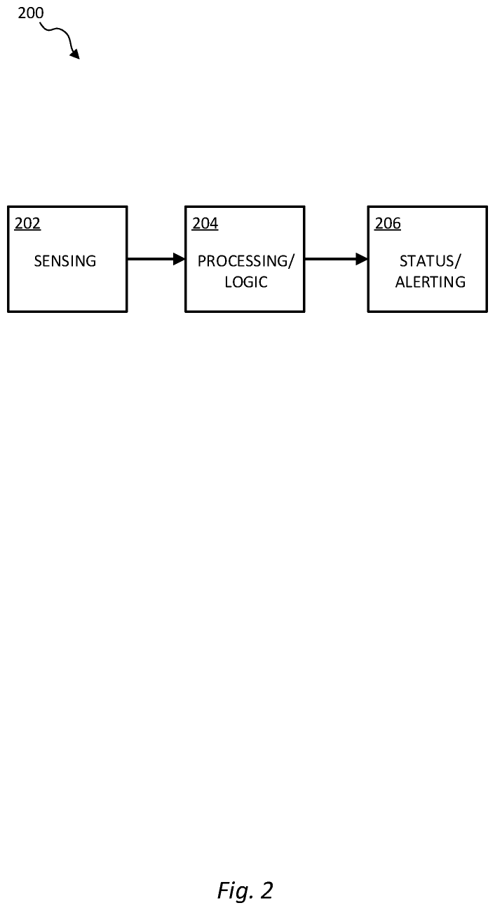

FIG. 2 is a depiction of high-level components and functions essential to implementing a system 200 according to embodiments of the present invention. Data are collected from sensed utility usage at sensing 202. Data is processed at logic 204 and results shared via status/alerting 206.

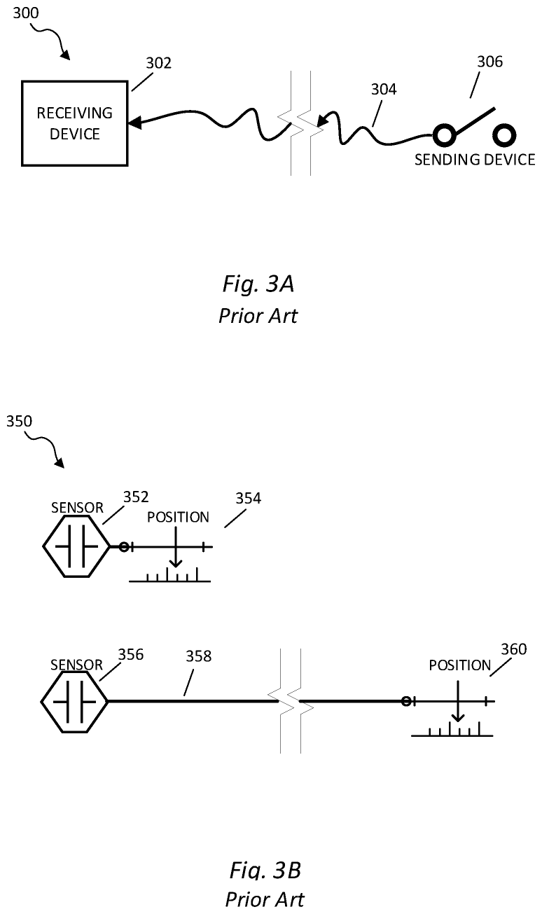

FIG. 3A and FIG. 3B are schematic depictions of prior art methods and systems for signaling and remote sensing that will be helpful in illustrating particular features and advantages of the present invention. Referring to FIG. 3A, prior art system 300 shows a signaling system. Sending device 306 uses connection 304 to send a signal that is detected by receiving device 302. System 300 may be implemented using many types of media for carrying the signal between sending device 306 and receiving device 302. For example, the media may be an electric current that is modulated or interrupted by sending device 302 and the flow of electricity through connection 304 is detected at receiving device 302. Such a system is the basis of many signaling systems, including telegraph, telephone, television, and computer networks.

FIG. 3B depicts prior art system 350 wherein the range of a sensor is extended through communication means. Position sensor 352 senses physical position 354 of an object physically near to sensor 352. Position sensing is used for illustration but those familiar with the art will understand similar means may be applied to many types of sensing and sensors. Still referring to FIG. 3B, sensor 356 senses remote position 360 through signal and physical communication provided by connecting rod 358. Thus, the range of sensor 356 is extended to a greater distance using communication means provided by connecting rod 358.

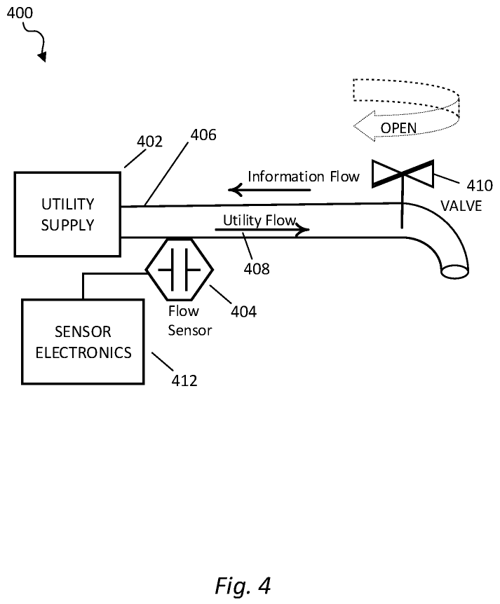

FIG. 4 depicts an embodiment of the present invention where a utility network is used for signaling or remote sensing. System 400 shows utility supply 402 connected to utility delivery network 406 that delivers utility media 408 to remote locations, for example the location of valve 410. Although a simple network 406 and a single valve 410 is shown, this is for simplicity of explanation only and embodiments of the invention may be implemented on arbitrarily complex networks with many valves.

It will be appreciated that in system 400 of FIG. 4, utility media 408 flows from utility supply 402 through utility network 406 only when valve 410 is opened. It may be further appreciated that this flow is sensed by flow sensor 404 in combination with sensor electronics 412. Thus, the status of valve 410 is detectable at any point in network 406 by sensing flow of utility media 408, and such flow sensing is provided by sensor 404 in combination with sensing electronics 412. In one embodiment system 400 provides a binary signaling capability where sensor electronics 412 detects two states of flow through network 406, on or off, corresponding to flow or no-flow, and only determines if valve 410 is fully closed or not closed. In another embodiment, a continuously variable analog signaling capability is provided wherein sensor 404 and sensor electronics 412 detect the amount or velocity of flow of utility media 408, which in turn provides remote sensing of position and degree of openness of valve 410.

A limitation and feature of system 400 is that the flow of utility media 408 is unidirectional and always flows from supply 402 to outlets such as valve 410. The signaling and sensing relies on information flow that is contrary in direction to the flow of utility media 408. This provides a useful feature in various embodiments, where the location of sensor 404 may be selected to provide sensing of a desired sub-network of a complex utility network. Essentially sensor 404 senses only flow that is downstream (i.e., flow past sensor in a direction away from supply 402) of its location in the network. This is used, in various embodiments, to separate various sub-networks for more specific sensing.

Referring back to FIG. 3B (prior art), it may be appreciated that the function of connecting rod 358 only requires that rod 358 be continuous and made from relatively inflexible material. The function of rod 358 does not depend on the material, which may be metal, plastic, wood, or composites, or a combination. Similarly, in embodiments of the present invention, the sensing range of sensor 404 is extended by utility media 408. The function of utility media 408 is not dependent on the type of media, only requiring a media type that is contained within a closed system and relatively incompressible such as water in plumbing, or electron flow in wiring, or pressurized gas in hose or tubing.

In one embodiment, media 408 is electricity or the flow of electrons, and media network 406 is electrical wiring, and signal communication is provided by electrical communication via electron flow.

In another embodiment, media 408 is water at a temperature greater than room temperature (i.e., hot water), and network 406 is a plumbing system, and signal communication is provided by counter-directional fluidic communication. In such an embodiment, Sensor 404 may utilize differing means to sense flow of media 408. In one embodiment, sensor 404 detects flow of hot water through network 406 by measuring temperature of pipes comprising network 406, specifically measuring pipe temperature in at least one selected location in network 406. In another embodiment, sensor 404 detects flow of hot water through network 406 by measuring temperature rate of change of the outside surface of pipes comprising network 406, specifically measuring temperature rate in at least one selected location in network 408. Algorithms for using pipe temperature or temperature rate sensing to infer flow according to embodiments of the invention are described elsewhere in the present disclosure.

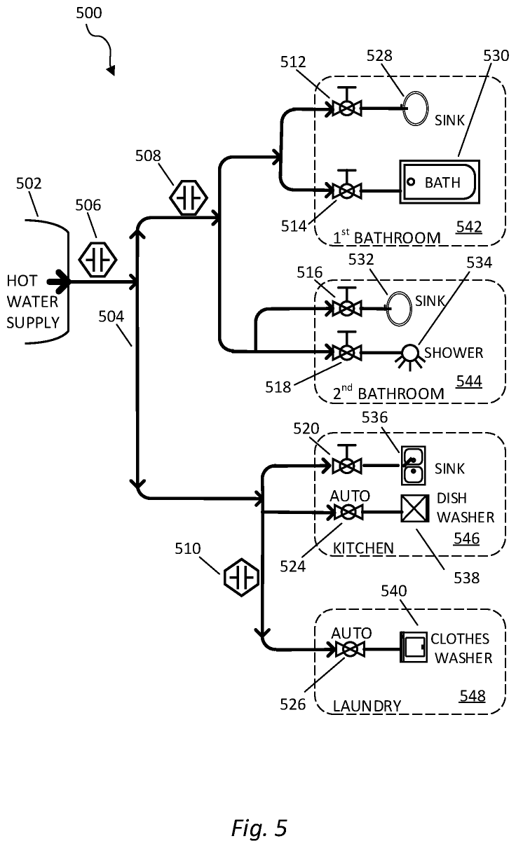

FIG. 5 depicts a utility network system in which embodiments of the present invention may be utilized. It is a particular feature that embodiments of the present invention may be installed into any arbitrary utility network without modification to the existing network configuration. It is also a feature of the present invention that embodiments may also be designed into a newly installed network, as in construction of a new home, apartment, or commercial facility. Thus, the invention is well suited both as an addition to an existing system, and also as a component of new construction.

It should be understood that in FIG. 5 and subsequent figures, a sensor is often shown without showing connections to other electronics or signal processing. This is for simplicity only as these connections are described elsewhere herein and it should be understood every sensor is connected to electronics and signal processing that are implied but not depicted in all figures; no sensor is standalone.

In the embodiment shown in FIG. 5, system 500 is a residential hot water utility delivery network comprising hot water supply 502 providing hot water to residential plumbing network 504. Hot water supply 502 may be derived from any source, for example, using gas, electricity, or solar energy to heat “cold” water. Cold water is a term used to refer to water at the temperature delivered from the supply—often a municipal utility supply or a well. It is assumed and common that such utility supply is delivered with adequate pressure to ensure useful flow in network 504 and in some cases the pressure is augmented by tanks, pumps, or the like.

The depicted plumbing network 504 and components in system 500 are greatly simplified and intended to represent the wide variety of configurations and connections compatible with embodiments of the present invention, rather than to imply any limitation or preferred configuration and no limitation should be inferred from the simplified diagram.

In some embodiments of the present invention, hot water flow is sensed in a hot water delivery network. This sensing is enabled by observed characteristic behavior of hot water delivery networks, which are consequences of basic principles of physics and thermodynamics. First, it is observed that most residential hot water systems supply hot water at a temperature of 110 to 125 degrees F., and said temperature is significantly above the ambient temperature in all but the most extreme climates and environments. When hot water flows into the plumbing comprising the hot water delivery network, the pipes are heated and the flow is detected by sensing the increasing surface temperature of the plumbing, or particularly at a pipe surface at a selected point in the plumbing network, due to transfer of heat from the flowing fluid to the material comprising the pipes and junctions.

Utility piping is usually comprised of pipes made from materials such as copper, galvanized iron, polyvinyl chloride (PVC), cross-linked polyethylene (PEX), acrylonitrile butadiene styrene (ABS), or combinations of these. Although these piping materials all have different heat conduction properties, all these and various other piping materials are suitable for application of the present invention.

Conversely when water is not flowing, the elevated surface temperature in combination with the fact that the pipe temperature is greater than the ambient surroundings, causes the pipe and the contained stagnant water to begin to cool, and continue to cool until an equilibrium temperature near ambient is reached at the pipe surface and in the contained liquid. However, when hot water again begins flowing in the pipe (i.e. in response to a new demand for hot water by opening a valve or faucet at any point in the plumbing network), the surface temperature of the pipes in the plumbing network rapidly begins to rise until it reaches a temperature near the temperature of the flowing hot water within the pipe. This cycle continues as valves are opened and closed throughout the plumbing network.

It is further notable that the sensing of flow using a measurement of the surface temperature of a pipe does not require a sensor or system to measure the absolute temperature of the pipe surface in a unit such as degrees Fahrenheit. Rather, it is sufficient to measure the change of pipe surface temperature over time, or the change of temperature over some pre-determined time interval. Additional detection uses sensing temperature maximums, again unit-less, and also without the need to sense absolute temperature, only that a temperature at a point in time is higher than other contemporaneously observed temperatures. Rising temperature corresponds to positive rates and hot water flow, while negative rates and decreasing temperature is observed when water is not flowing, or has ceased flowing, corresponding to no demand for hot water, i.e. a faucet or valve that was opened has subsequently been closed.

A maximum temperature measurement indicates that a pipe has reached equilibrium, or that the pipe surface temperature is the same as the temperature of the elevated temperature water flowing within or indicates that internal pipe flow has stopped before the pipe reached the temperature of the internal hot water. Correspondingly, a minimum temperature indicates that the pipe surface and liquid within have decreased in temperature to match ambient surroundings or that flow was restarted before the pipe reached ambient. Those familiar with the mathematics of the art will appreciate that a maximum or minimum temperature corresponds to a point in time where the rate of change of temperature, or time derivative, of the measured temperature is zero. Thus, there is a mathematical connection between measuring rates and detecting a maximum or minimum temperature, and detection algorithms according to embodiments are built upon distinguishing intervals of positive, negative, or zero rate of change.

Relying on rate of change of pipe surface temperature and relative maximums, rather than measuring absolute temperature, has a number of advantages in practical implementations. First, sensing a temperature rate or maximum is much less demanding for a sensor, allowing less expensive sensors to be selected. Even sensors that have poor absolute measurement accuracy may be used to accurately sense a relative temperature—that is, a difference in temperature over a relatively short time interval. In other words, it is much easier to sense that a temperature of an object is increasing or decreasing or at a maximum, rather than sense the absolute temperature of the object. In addition, the installation and setup of the system is simplified. A system requiring absolute temperature measurement would typically require careful installation and calibration, adding effort and expense. A system relying on measurement of relative temperature and temperature rate is much easier to install and requires no such calibration.

Specific details of techniques used in embodiments of the invention for using time rate of change of pipe surface temperature to sense flow of hot water within the pipe, are described in conjunction with other sections and figures herein.

Referring to FIG. 5, Hot water plumbing network 504 provides hot water to various locations in a residence. Four illustrative rooms are depicted for simplicity of explanation but not to imply any limitation—an actual residence is likely to have many more rooms and plumbing fixtures and a much more extensive plumbing network, and the present invention is in no way limited in application to any room, type of room, plumbing devices, number of rooms, plumbing network size, or fixtures. Network 504 connects to 1^{st} Bathroom 542, supplying sink 528, controlled by valve 512, and bathtub 530 controlled by valve 514. Network 504 also connects to 2^{nd} bathroom 544, supplying sink 532 controlled by valve 518, and shower 534 controlled by valve 518. Network 504 similarly connects to kitchen 546 where valve 520 controls supply to sink 536, and valve 524 controls supply to dishwasher 538. Network 504 also connects to laundry room 548, where valve 526 controls flow to clothes washer appliance 540.

The present invention relies on flow detection in network 504 provided by sensors 506, 508, and 510. Three sensors are shown but it should be appreciated that fewer or more sensors may be used in accordance with embodiments of the present invention. In fact, complete embodiments of the present invention may be practiced with a single sensor, such as sensor 506. In an embodiment, sensor 506 is used as the only sensor and is advantageously located as near as possible to hot water supply 502. For example, hot water supply 502 is generated by a hot water heating appliance such as Bradford-White model RG130T6N gas fired Residential Water Heater. The present invention works equally well with any hot water source, whether gas, electric, solar, residential, or commercial, and whether with a tank or tankless design. In embodiments using a single hot water flow sensor, the sensor is most advantageously located as near as practical to the point of entry of the hot water into network 504, which in most cases corresponds to the exit piping where heated water leaves the heating appliance. This, as discussed above, provides maximal sensing of usage anywhere in the residence because all of network 504 is downstream of sensor 506 when so located. This corresponds, referring to FIG. 5, to sensor 506 located at point of entrance of hot water supply 502.

In other embodiments, additional sensors provide additional flow detection. In system 500 of FIG. 5 an embodiment including three sensors 506, 508, and 510 is illustrative. Sensor 506 will detect flow of hot water to any device connected to the plumbing network 504. Sensor 508 detects usage downstream, so only detects usage in 1^{st} bathroom 542 or 2^{nd} bathroom 544. Similarly, sensor 510 detects usage in laundry room 510.

It may be appreciated that plumbing system 504 is a closed system with finite and pre-determined entry and exit points, and therefore any flow detected by sensor 506 must correspond to usage at a connected location so logical inferences may be made. For example, in system 500, if flow is detected by sensor 506 but no flow is detected by sensor 508 nor by sensor 510 then it may be inferred that hot water is flowing to kitchen 546 and not to any other room.

In various embodiments, the present invention detects human activity that corresponds to usage of utilities, in some embodiments, to usage of hot water. Referring again to FIG. 5, sensor 506 will detect activities such as bathing in shower 534 or bathtub 530, or use of sink 528 or sink 532 or kitchen sink 536. This is because the person will operate the corresponding valve—one of valves 512, 514, 516, 518, or 520, which are each manually operated valves. Operation of a valve creates flow, and flow is detected. There are also automatically operated valves such as valve 524 for dishwasher appliance 538 and valve 526 for clothes washer appliance 540. Although valves 524 and 526 are not manually operated, their use corresponds to human activity because they are secondary results of human actions—either initiating a washing cycle at clothes washer appliance 540 or at dish washer appliance 538, requiring a human to prepare and activate the corresponding appliance. Although these appliances operate on an automatic programmed cycle once initiated, each cycle must be initiated by a human operator using specific control inputs.

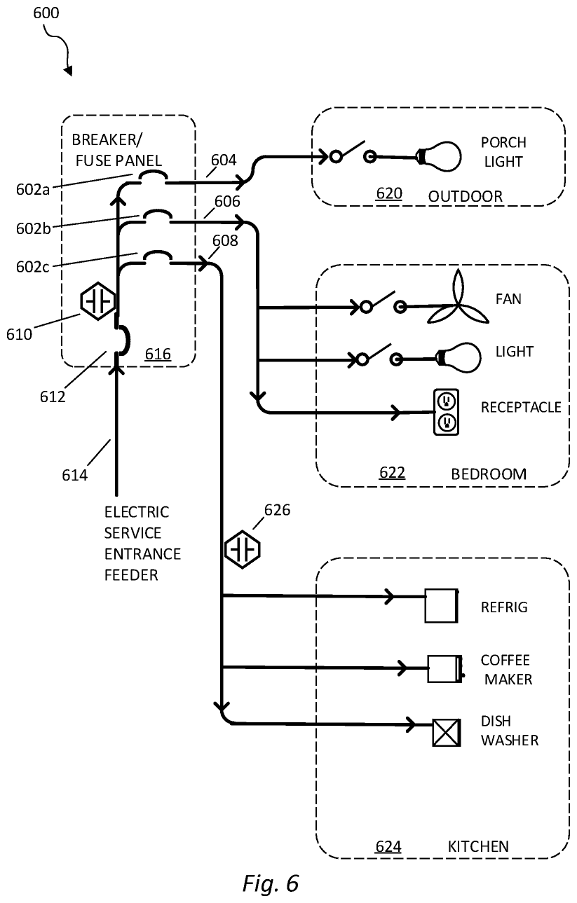

FIG. 6 schematically depicts another utility network system in which embodiments of the present invention may be utilized. System 600 is a schematic depiction of a residential electricity utility delivery network. It should be noted, with reference to FIG. 5 and FIG. 6, that the present invention as described herein is not limited to any particular type of utility or specific utility delivery network. Where descriptions or illustrations refer to specific type of sensor appropriate for one type of utility and utility network, those skilled in the art will understand that the invention description is readily adapted to other types of utilities by substitution of an appropriate sensor. For example, those skilled in the art recognize that sensing flow of electricity requires an ammeter or electrical current flow detector.

Referring to FIG. 6 and system 600, electric utility service enters the residence at service feeder 614 and is connected in breaker/fuse panel 616. Most, but not all residences have main breaker 612 and at least one branch circuit breaker 602. Each branch circuit breaker 602 controls and protects corresponding branch circuit 604, 608, or 610. Branch circuit 604 supplies electrical utility feed to outdoor 620. Branch circuit 606 supplies electrical utility feed to bedroom 622. Branch circuit 608 supplies electrical utility feed to kitchen 624.

In various embodiments, a single sensor 610 is sufficient to implement the present invention, and sensor 610 is advantageously located to sense flow of electricity through entire utility network by locating sensor 610 upstream of branch breakers 602. In another embodiment, additional sensors such as sensor 626 are installed. Sensor 626 is installed in location to sense only electric usage in kitchen 624.

A notable aspect according to embodiments, is that certain appliances use multiple types of utility and thus connect to multiple utility networks. For example, a clothes washing appliance connects to electric, hot water, and cold-water delivery networks and uses those utilities in unique and recognizable pattern. Similarly, an automatic dishwasher or heating unit connects to multiple networks and uses those in a unique pattern and combination.

It should be noted that although descriptions of embodiments herein often include only a single sensor, or a single type of utility or sensed usage of residential utility delivery network, some embodiments of the present invention include multiple sensors and sensing usage in a plurality of types of utility networks in a residence. Additional sensors provide additional data and time correlation and fusion of data from multiple sensors to further detect usage patterns and human activity is in the scope of embodiments the present invention.

However, embodiments with multiple sensors or sensing multiple utility types require more thorough knowledge of the utility network topology and location of sensors, as well as more complex sensor data collection and connections.

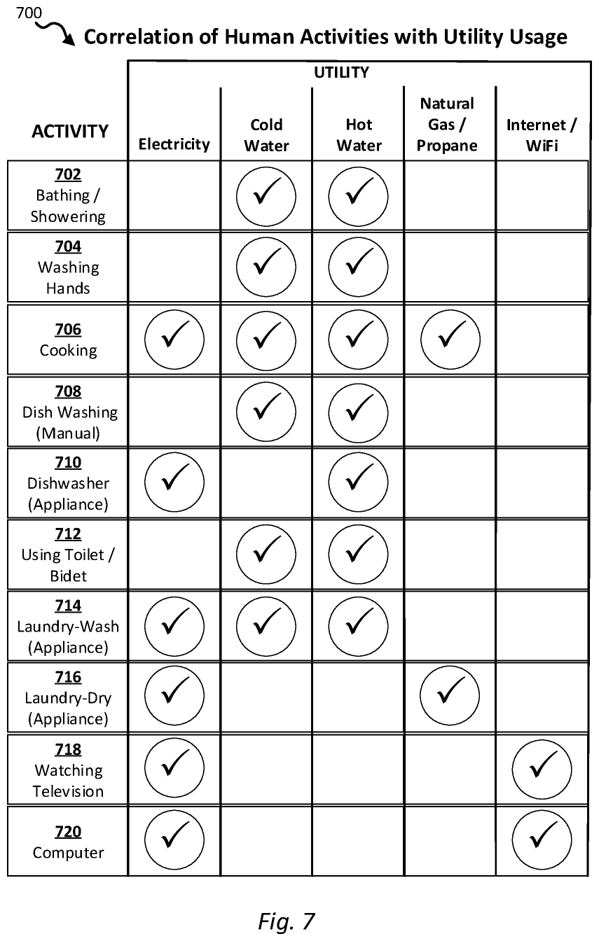

FIG. 7 illustrates the correlation between human activity and usage of utilities in a residence, a correlation that forms the basis for embodiments of the present invention. As shown in FIG. 7, of the many utility types, hot water usage correlates to the widest variety of human activities and several that correspond to the ADL measures. As detailed elsewhere in this disclosure, embodiments of the present invention are particularly suited for detection of flow of hot water utility. However, embodiments of the present invention may be implemented using any utility and corresponding sensing of usage.

In addition to correlation of human activities with utility usage, embodiments of the present invention are based on the observation that people, especially those able to live independently and maintain a positive well-being status, tend to follow routines that repeat daily, weekly, or maintain a routine for each day of the week. For example, utility usage by a person may differ slightly between consecutive weekdays, on weekends, or between corresponding past weekdays (e.g., a Tuesday compared to previous week Tuesday). In general, usage by a particular person exhibits patterns that may be observed, generalized, noted, and used to detect cause for concern. This is due to repetition of activities that cause utility usage, for example showering, washing dishes, or doing laundry, which tend to correspond to the particular person's typical daily schedule of waking, bathing, eating, or washing clothes.

In particular, a person deviating significantly from a past routine of utility usage times and durations, or events as used in the present invention, is likely in need of assistance or experiencing some difficulty. It may be appreciated that people will change behavior for reasons other than being in distress or needing help. A feature of embodiments of the present invention is automatic separation to distinguish changes that require assistance or further attention, from changes in patterns that are merely variation of habits or responses to changes in schedule, seasons, weather, or the like. It is a further feature of the present invention that a human user may interact with the detection logic to pause or stop notifications when it is known that lack of usage may not indicate an actual need for assistance, as during a vacation.

Maintaining Activities of Daily Life (ADLs) is highly correlated with usage of utilities—electricity, gas, internet, water. In particular, hot water usage may be a proxy for a person maintaining essential ADL functions, especially mobility, eating, and bathing. Monitoring utilities may often be accomplished simply, without invasion of privacy or intrusive sensors, and using utilities is a natural and organic part of daily living so provides an easily monitored and effective detection of a person's well-being status.

While ADLs provide a generic non-personalized monitoring standard, monitoring utility usage may be expanded to provide more sophisticated and personalized monitoring, when combined with advanced signal detection, processing, and storage. Such a system may be configured to learn the normal patterns of behavior of an individual and compare ongoing usage to detect when behavior differs from the learned normal or shows anomalies that are cause for concern. Thus, in various embodiments, a monitoring scheme is provided that is tailored to the habits and routines of an individual being monitored.

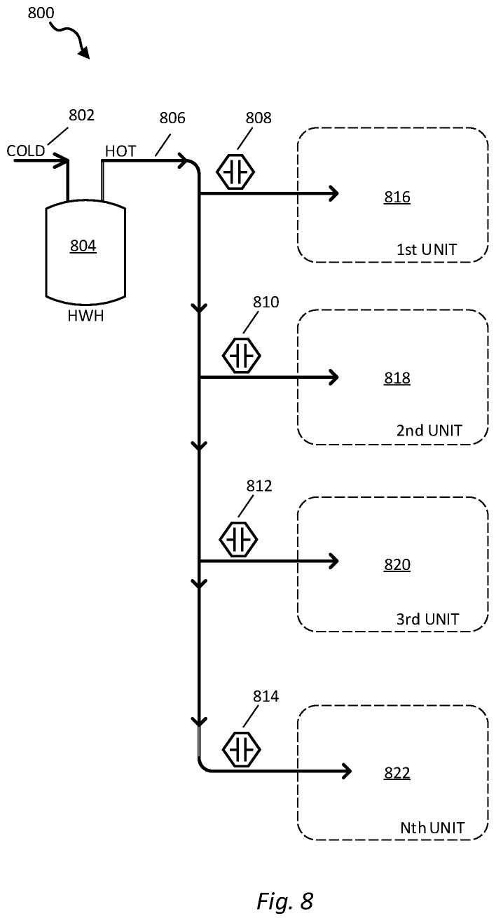

FIG. 8 schematically depicts applying embodiments of the present invention to a multi-unit dwelling utility network with a shared hot water heater that supplies all units. In system 800, cold water supply 802 provides water to hot water heater 804 supplying hot water distribution network 806. Four residential units are shown-1^{st} Unit 816, 2^{nd} Unit 818, 3^{rd} Unit 820 and Nth Unit 522. The number of units depicted is small to facilitate explanation of embodiments in a simple fashion and does not imply any limitation on the number of units that may be used in accordance with the teachings of the present invention. In actual embodiments, the number of units scale to hundreds, thousands, or more. The utility itself may only monitor the resources provided to the multi-unit dwelling even though resources are provided to several residences individually, however, embodiments of the invention have sensors located in one or more residences of the multi-unit dwelling to separately monitor the utility resources consumed in each unit having a sensor.

In embodiments where it is desirable to separately detect usage in each of the units 816, 816, 820, and 822, a sensor is dedicated to each unit. In some embodiments, it is desired to only monitor a subset of all units, or only a single unit, and sensors need only be installed corresponding to units to be monitored.

Referring to FIG. 8 and in accordance with the discussion above, sensor 808 detects usage in unit 816, sensor 810 detects usage in unit 818, sensor 812 detects usage in unit 830, and sensor 814 detects usage in unit 822.

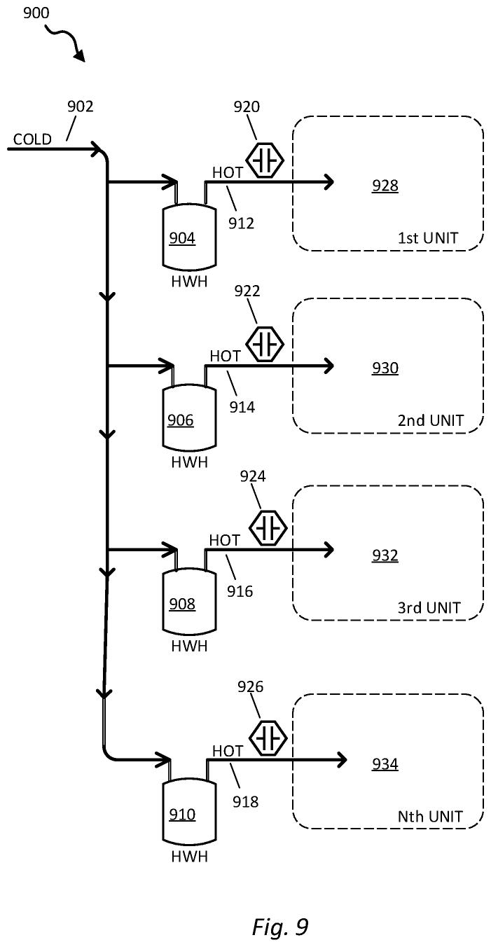

FIG. 9 schematically depicts applying embodiments of the present invention to a utility network in a multi-unit dwelling where each dwelling has a dedicated hot water heater. In system 900, four residential units are shown-1st Unit 928, 2nd Unit 930, 3rd Unit 932 and Nth Unit 934. The number of units is small to facilitate explanation of embodiments in a simple fashion and does not imply any limitation on the number of units that may be used in accordance with the teachings of the present invention. In actual embodiments, the number of units scale to hundreds, thousands, or more. Cold water supply 902 provides water to hot water heater 904 supplying Hot Water Distribution Network 912 to unit 928. Cold water supply 902 provides water to hot water heater 906 supplying Hot Water Distribution Network 914 to unit 930. Cold water supply 902 provides water to hot water heater 908 supplying Hot Water Distribution Network 916 to unit 932. Cold water supply 902 provides water to hot water heater 910 supplying Hot Water Distribution Network 918 to unit 934.

In embodiments where it is desirable to separately detect usage in each of the units, a sensor is dedicated to each unit. In some embodiments, it is desired to only monitor a subset of all units, or only a single unit, then sensors need only be installed corresponding to a unit to be monitored.

Referring to FIG. 9 and in accordance with the discussion above, sensor 920 detects usage in Unit 928, sensor 922 detects usage in unit 930, sensor 924 detects usage in unit 932, and sensor 926 detects usage in Unit 934.

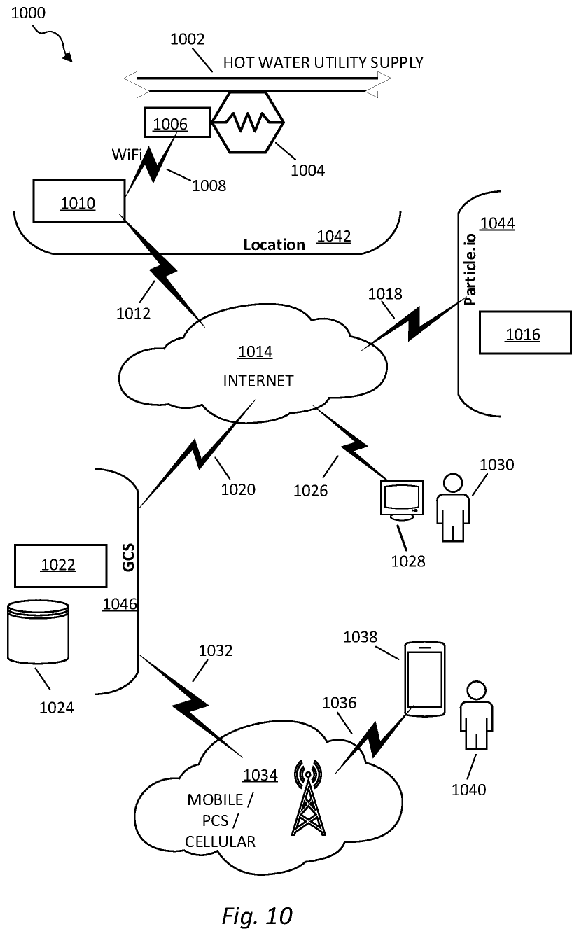

FIG. 10 depicts a detailed embodiment of components and devices arranged to implement an embodiment of the present invention in system 1000. In the event that hot water flows in plumbing network 1002, flow sensor 1004 detects the flow by measuring the temperature of the outside surface of a pipe component at a selected location in plumbing network 1002. As detailed elsewhere in the descriptions herein, flow sensor 1004 is located at a selected advantageous location in plumbing network 1002. In the described embodiment the location is at the entry of hot water into plumbing network 1002.

In one embodiment sensor 1004 is an NTC thermistor of type TH310J39GBSN(25/85) manufactured by Amphenol Advanced Sensors, although other similar sensors may be equivalent in function or performance or be substituitable. Those familiar with the art will appreciate that a thermistor sensor must be attached to an excitation network. Often a thermistor is configured as a part of a voltage divider and a voltage corresponding to temperature is measured. The excitation network and temperature measurement are provided by processing electronics 1006. Processing electronics 1006 also connects to the internet 1014 through communication link 1008, WiFi Router/Gateway 1010, and network data connection 1012. In some embodiments, processing electronics 1006 maintains the present time and periodically synchronizes with internet time servers to maintain a local clock that supplies accurate time.

Those familiar with the art will readily understand the mechanism, methods, and configuration for connection to the internet 1014 using commonly available network components such as Router/Gateway 1010 and will also understand that various protocols and encoding techniques may be used to transfer data and synchronize with time servers, all in accordance with the invention described herein. Nothing in the invention relies on a specific data network or type of communication, but only requires that a suitable network connection is provided.

In one embodiment, processing electronics 1006 includes a small computer with a WiFi network interface, model Photon, available from Particle Industries Incorporated of San Francisco, Calif. Processing electronics 1006 in this embodiment also includes a voltage divider excitation circuit for thermistor sensor 1004.

Processing electronics 1006 and sensor 1004 periodically measure the temperature of the pipe surface in plumbing network 1002 and transmit the temperature and measurement time to IoT (Internet of Things) server 1016, transferring data via WiFi link 1008, WiFi Router/Gateway 1012, internet connection 1012, and Internet 1014, internet connection 1019, to IoT server 1016.

IoT server 1016 sends the measured data and time tags to Google Compute Services (GCS) server 1022 via internet connection 1018, internet 1014, and internet connection 1020. In the embodiment of system 1000, GCS server 1022 operates in conjunction with GCS Database 1024 to provide data processing and storage. Although a single server is shown as GCS Server 1022, and a single Database 1024, those familiar with the art recognize that GCS is a collection of many servers and data base servers, all operating in conjunction, and that from an implementation perspective and for purposes of the descriptions of the invention herein, they may be treated as if they were a single computer device without loss of any detail.

A particular feature of the present invention is illustrated by the embodiment described in FIG. 10 and system 1000, in that the functional process steps required (as described in reference to FIG. 2) are distributed among multiple computing and storage elements that are geographically distributed and connected via internet 1014 and appropriate connections 1012, 1018, and 1020. It should be appreciated that many embodiments with different distributions of processing, storage, and communication links may be implemented without departing from the spirit of the invention described herein. In particular, FIG. 2 describes processing/logic 204, which is implemented in the embodiment of system 1000 as distributed among processing electronics 1006, IoT Server 1016 and GCS Server 1022, using corresponding communication links 1012, 1018, and 1020 with internet 1014. This is only one possible distribution of functions and processing; many other distributions are possible, all in accordance with the present invention.

This feature of flexible and configurable location and distribution allows an implementer of the present invention to select a desirable distribution of functions, for example to simplify implementation, use existing components or features, minimize expense, or maximize throughput. In the embodiment of system 1000, processing is distributed between three locations. Although these locations may be imagined to be geographical, they are better conceived as virtual locations in the internet cloud. Their physical or geographical locations are not important and are in fact often unknown to the user or designer.

In the embodiment of system 1000, processing that is advantageously performed locally near to sensor 1004 is performed at processing electronics 1006, physically in location 1042 which corresponds to a residence being monitored at location 1042. In this embodiment, the Photon device is particularly suited to communicate with IoT Server 1016, located at Particle.io location 1044. Server 1016 is shown as single server for simplicity but particle.io may actually have many servers and many locations. Finally, GCS 1046 provides server 1022 and database 1024.

It should also be appreciated that although a single location 1042 and sensor is illustrated in FIG. 10, this is to simplify the description of the invention. In actual implementations, the invention supports many residences, sensors, and locations and readily scales to thousands or millions of locations and corresponding sensors.

Still referring to FIG. 10, in the depicted embodiment of system 1000, GCS Server 1022 and GCS Database 1024 receive the sensor data and implement the data processing functions described herein and further detailed in other sections. As described, this results in a status determination of the person being monitored. The status determination is updated periodically and made available via Web Servers on GCS Server 1022.

This status may be accessed using any suitable internet web browsing device and browser application. In one embodiment, an application program that displays status and allows status queries is provided that is installable on a wireless portable communication device, such as a smart phone, tablet computer, or portable computer. Further details of the status and alerting and associated application program are described subsequently in the present application.

Referring to FIG. 10, user 1030 uses browser 1028 via internet links 1026 and 1020 to access a web page on GCS Server 1022. Alternatively, user 1040 accesses a web page on GCS Server 1023 vial link 1036, cellular data network 1034, and link 1032.

GCS Server 1022 also implements an algorithm, described further herein elsewhere, to determine if an alert should be sent to user 1040. In actual implementation there may be thousands or millions of users corresponding to user 1040 and user 1030. These are representative of one of those many users and it should be understood that the present invention is most useful, and designed, to scale to many thousands or millions of users.

Accordingly, if the algorithms and logic in GCS Server 1022 result in a conclusion that an alert should be sent, based on the data from a particular location, an alert is sent to subscribed user 1040 and wireless device 1038 using mobile links 1032 and 1036 and mobile network 1034.

In one embodiment, the text alert is provided as a text message, for example an SMS format message, and the messaging service relay is provided by Twillio of San Francisco, Calif.

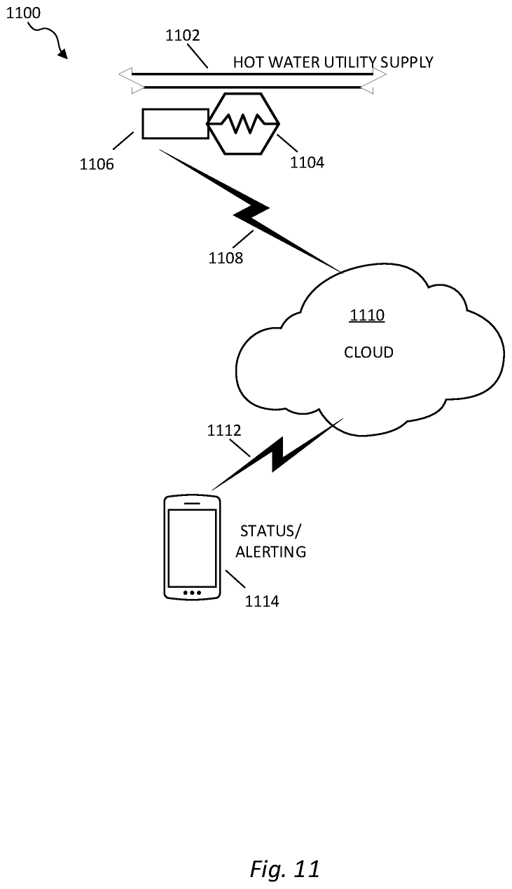

FIG. 11 shows a detailed depiction of another embodiment according to descriptions of the present invention in system 1100. This is to illustrate the flexibility and wide range of implementations and embodiments possible, all consistent with the present invention. In system 1100, in the event that hot water flows in plumbing network 1102, flow sensor 1104 detects the flow by measuring the temperature of the outside surface of a pipe component in plumbing network 1102.

In one embodiment sensor 1104 is an infrared non-contact sensor. The excitation network and temperature measurement are provided by computing electronics 1106. Computing electronics 1106 connects to network cloud 1110 through communication link 1108. Link 1108 is, in various embodiments, implemented using wired or wireless networking technology, with data communication provided by WiFi, Ethernet, Bluetooth, cellular data, or WWAN, or by any combination of these. In some embodiments, computing electronics 1106 maintains the present time and periodically synchronizes with time servers to maintain and provide accurate timekeeping.

Also connected to network cloud 1110 is smartphone 1114 through communication link 1112. All data processing functions in this embodiment are executed by computing electronics 1106, in smartphone 1114, or in cloud computing resources (not shown).

The embodiment in system 1100 has several notable differences from the embodiment of system 1000 in FIG. 10, further illustrating that the invention herein does not rely on any specific sensor type, network connection, distribution of computational tasks among available resources, or communication link.

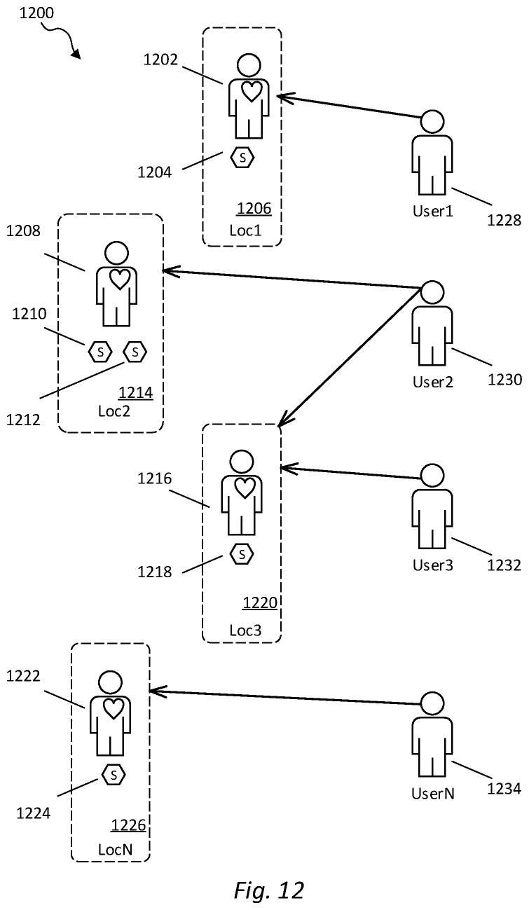

FIG. 12 is a pictorial description of a data structure and hierarchy used in embodiments of the present invention. The data hierarchy 1200 depicted in FIG. 12 illustrates how embodiments of the present invention scale essentially without limit, for example to thousands or millions of persons monitored, sensors, locations, and users.

Many of the descriptions presented herein show only one or a small quantity of various components in illustrations of various embodiments, for simplicity of illustration and description. However, it should be understood that embodiments of the present invention may scale to support thousands or millions of components.

Referring to FIG. 12, four locations are shown to represent a number of locations, and in embodiments a large number of locations are included. Person monitored 1202 is at location 1206, person monitored 1208 is at location 1214, person monitored 1216 is at location 1220, and Nth person monitored 1222 is at location 1226.

Each location has one or more utility usage sensors. Location 1206 has sensor 1204. Location 1214 has sensors 1210 and 1212. Location 1220 has sensor 1218. Location 1226 has sensor 1224. It may be seen that the concept of “location” is affiliated with a single person monitored and one or more sensors that monitor the well-being of the person monitored, through utility flow detection and processing.

In FIG. 12, four users 1228, 1230, 1232, and 1234 are shown to represent a large number of users. A user in this embodiment and elsewhere herein is a person who wishes to track the health and well-being of a person monitored. Each user may subscribe to receive alerts and status of none or any set of the persons monitored 1202, 1208, 1216 or 1222. In the illustrated embodiment, this subscription may be multi-valued, that is any of locations 1206, 1214, 1220, or 1226 may be subscribed by more than one of users 1228, 1230, 1232, or 1234. This is shown in FIG. 12 where user 1230 is subscribed to both person monitored 1208 (location 1214) and to person monitored 1215 (location 1220).

Similarly, a location may be subscribed-to by more than one user simultaneously. This is shown in FIG. 12 as location 1220 (Person monitored 1216) is subscribed by both user 1230 and user 1232.

The Data Hierarchy 1200 may be scaled up with no practical limit and incorporate a variety of configurations and components in various embodiments. Not shown and essential in embodiments of the invention are security mechanisms to allow only authorized users to monitor a person, to protect privacy and safety of persons monitored.

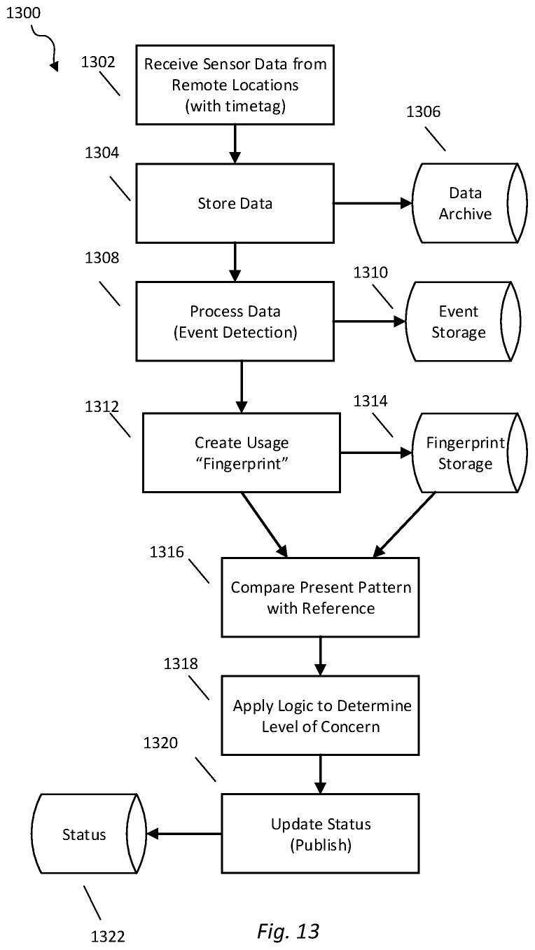

FIG. 13 illustrates flow of data, and process steps, and storage, in accordance with embodiments implementing the present invention. It should be appreciated that this sequence is performed for each person monitored and location. Data process 1300 begins at 1302 where sensor data and corresponding information such as time tag are received. At 1304 all received data is stored in archive 1306. At 1308 data is processed in accordance with embodiments of descriptions herein, including detection of utility usage events. Events are stored in data repository store 1310.

At 1312, event start times and durations are arranged in a time-based data structure “fingerprint” and recorded in fingerprint store 1314. In some embodiments, the fingerprint generated at 1312 is an algorithmic combination of new data with past data. In other embodiments, multiple fingerprints may be kept for a time period—for example, fingerprints from the last five (or any selected number) most recent Tuesdays may be kept in store 1314.

At 1316, the present (i.e., most recently observed) fingerprint is compared to a reference pattern. In various embodiments, the reference pattern may be from a standard set of criteria, from observation of past “typical” usage patterns for this person monitored, or from a set of rules defined, or another reference standard. In embodiments, pattern matching and contrasting determines if present usage patterns are cause for concern at 1318. At 1320 the status of the person monitored is stored in repository 1322.

FIG. 14A and 14B schematically depict sensor data and processing methods to detect flow and flow events in accordance with embodiments of the present invention. FIG. 14A shows a graphical display of various signals plotted vs. time, displayed on the horizontal axis. Signal 1402 is sensed temperature data from a single sensor attached to a hot water pipe and values correspond to the left vertical axis where temperature in degrees Fahrenheit is marked. Signal 1404 is the time derivative (instantaneous time rate-of-change) of temperature signal 1402. Signal 1404 is the binary result of an event detection algorithm according to an embodiment of the present invention, where a high value indicates and even duration and a low value indicates times when no detected event is happening.

In accordance with embodiments of descriptions of the present invention, a flow of hot water may be detected from a time series of temperature sensor data periodically sampled saved in a time history. This detection is illustrated in Graph 1400, where several flow events are highlighted. Flow event 1408, 1410, 1412, 1414, 1416, 1418, and 1420 are depicted in the figure. Each event is characterized by an initial or attack rate-of-change that exceeds a pre-determined threshold. Rate of change is plotted in signal 1404. Each event 1408, 1410, 1412, 1414, 1416, 1418, and 1420, then has a duration before the end of the event is detected based on a negative (less than zero) rate of change of temperature; temperature reaches a local maximum then begins to decrease.

It is a notable feature of an embodiment of the invention that detection of event beginning and ending relies only on rate of change and detection of a local maximum. In some embodiments, an instantaneous rate of change (time derivative) is used. In other embodiments, an average rate of temperature change over a time interval is used. In one embodiment, a cumulative temperature change corresponding to a rate of change of 5 degrees difference over a time interval of 120 seconds is used to determine that flow has been detected. This is implemented by comparing each value in a time series with the measurement made 120 seconds before and calculating the change or mathematical difference in the values, and comparing the values to a limit value, which corresponds to a 5-degree difference between the two measured values. It may be appreciated that this difference is calculated without need to calculate the absolute temperature in any units—a temperature difference limit value may be expressed in a unitless number such as raw readings from an analog to digital converter.

The reliance on rate of change and relative rather than absolute temperature measurement is a feature of embodiments of the invention and provides advantages including cost savings and ease of installation, because a sensor does not need to be of high absolute accuracy or require calibration that would be needed to provide an absolute temperature value in units such as degrees. Instead, less expensive sensors may be used, which provide sufficient accuracy in measuring change of temperature over short intervals, suitable for computing rates of change and detecting local maximums.

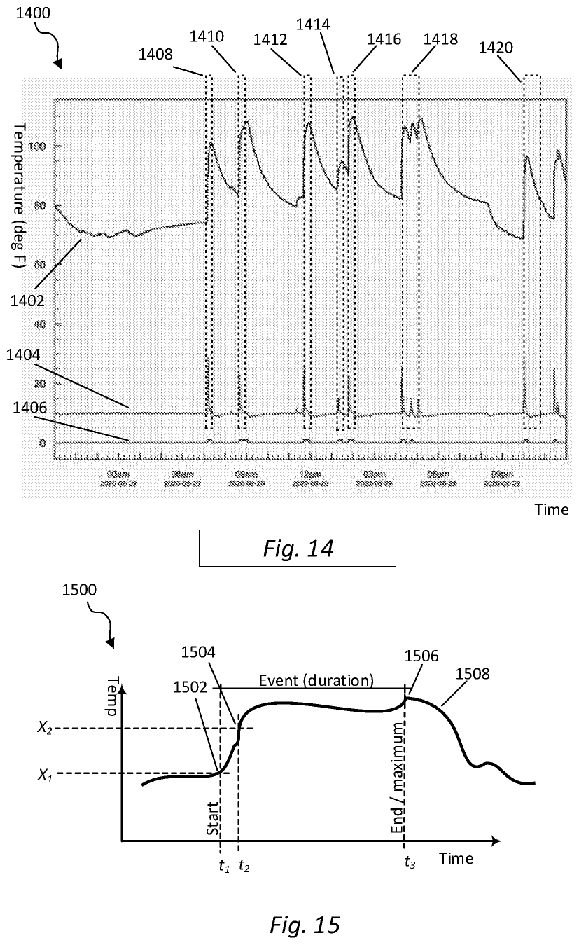

FIG. 15 shows further details of a hot water flow event detection algorithm based on embodiments of the invention. Graph 1500 illustrates a single event and notable detection criteria. Graph 1500 shows measured temperature data plotted with a horizontal axis of time and a vertical axis of temperature. At point 1502, corresponding to time t₁, no flow is detected and the data shows rest or equilibrium temperature X₁, but measured temperature is beginning to increase. Temperature increases until time t₂, where the plotted sensor data shows a detected increase in temperature to X₂. Because the rate of temperature increases from t₁to t₂ is at a rate that exceeds a pre-determined threshold a potential start event is detected.

It is essential to have a pre-determined rate threshold and measurement interval selected to filter out spurious triggers, and temperature increases that are be caused by events other than flow of hot water. For example, increase in ambient surrounding temperature due to weather, or space heaters. Or pipes near a hot water heater and a proximate sensor may be warmed when the heater burner or heating element switches on to heat the water. However, actual flow events create a larger rate of increase of temperature over a predetermined time and suitable temperature rate thresholds and intervals distinguish temperature change indicating flow, from other spurious temperature changes.

In one embodiment, a rate of increase of 5 degrees over a time interval of 120 seconds is the pre-defined trigger value to detect flow of hot water by rate of change of pipe surface temperature. In one embodiment, the pre-determined rate threshold is selected from a plurality of values, and the selection is based on season, weather forecast, or ambient temperature, to provide event detection best suited to present or expected conditions.

Referring again to FIG. 15, at point 1508, the temperature has decreased sufficiently to trigger a negative rate of change threshold detection. Accordingly, at point 1506, corresponding to time t₃, temperature is a maximum and begins to decrease, so temperature rate of change is less than zero and a flow event end is determined. A flow end event is only determined when a preceding flow start event has been found. The duration of the flow event depicted in plot 1500 is then determined to begin at t₁ and detected event duration is t₃-t₁. In some embodiments, a flow start event is detected and subsequent samples are tested to detect a flow end.

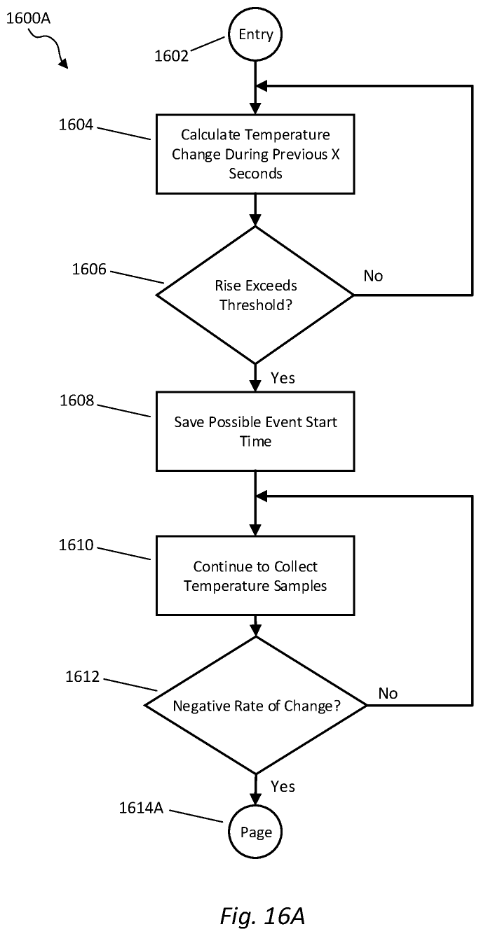

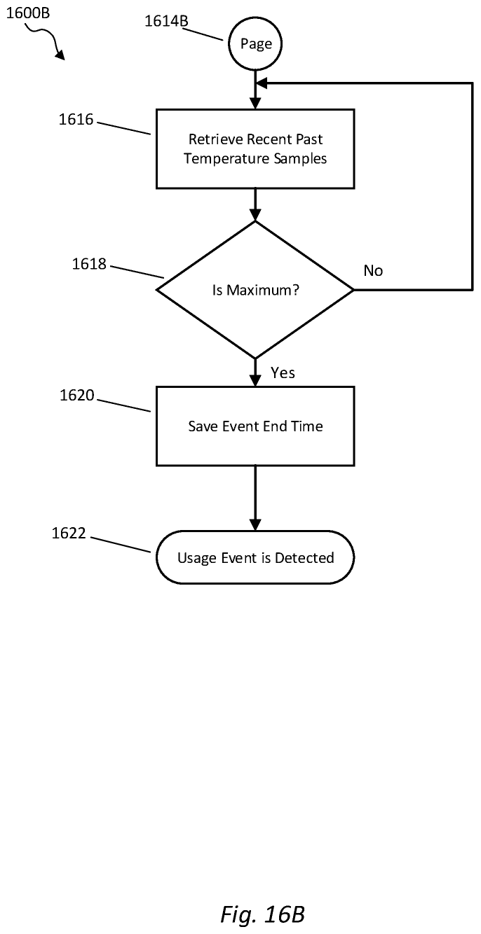

FIG. 16A and 16B comprise a flow chart illustrating detection of an event according to embodiments of the present invention. Process 1600 is split between two figures for clear illustration, and the two figures are connected at page connector 1614 and are intended to show a single process flow. Process 1600 begins at 1602. At 1604, time rate of temperature change is calculated over a pre-determined interval, or as an instantaneous time derivative. At 1606, rate of change is compared to a predetermine threshold. If the rate exceeds the threshold, processing continues at 1608 where the time of start of rate is saved as a candidate event start time. If the rate does not exceed the threshold, processing continues at 1604.

After a trend of sufficient positive rate is detected at 1606, processing continues with collection of temperature samples after the candidate start event, at 1610.

At 1612 samples are tested to detect a negative temperature rate. If test 1612 is true, processing continues at 1616 in FIG. 16B. If no negative rate is detected, processing loops and resumes at 1610.

Referring to FIG. 16B, processing continues at 1616 after a negative rate sufficient to detect has been detected. At 1618, recent samples prior to the negative rate are tested to find a local maximum value at 1618. The loop comprising 1616 and 1618 continues until the local maximum is found. When the maximum is found, processing continues at 1620 where the time corresponding to the maximum is determined to be the end event time. Processing concludes at 1622, where an event start and end have been detected, so the event detection is completed.

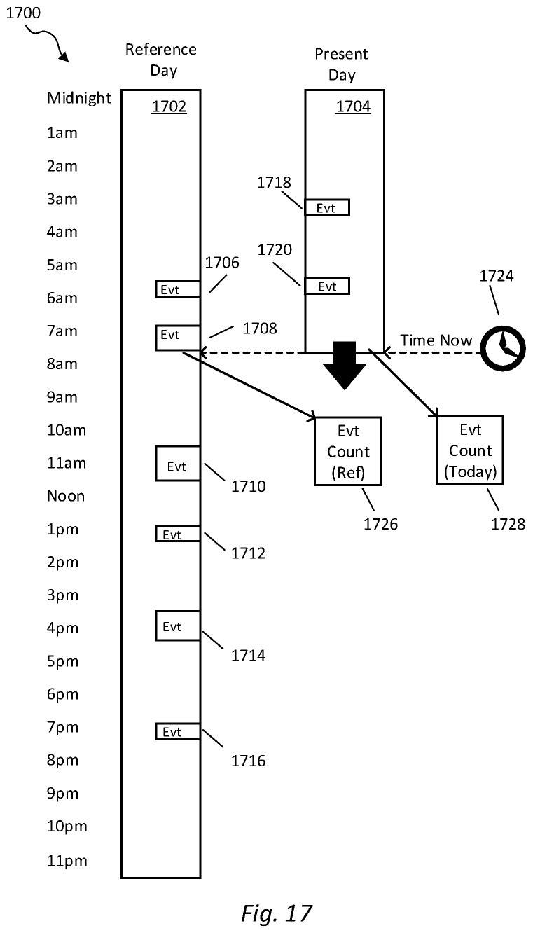

FIG. 17 depicts a schematic representation according to the present invention, for pattern matching to determine if a present usage pattern matches a reference usage pattern. Reference day 1702 contains intervals of flow events and intervals of no-flow mapped to time of day. Reference day 1702 shows a day with flow events 1706, 1708, 1710, 1712, 1714, and 1716. Present day 1704 shows collection of data up to the present time of day indicated by clock 1724. At present time in present day 1704, there have been two flow events 1718 and 1720.

There are many techniques for matching present day pattern 1704 against reference pattern 1702, all in accordance with the teachings of the present invention. Various techniques used in embodiments are described, and in some embodiments multiple techniques may be employed in series, in an overlapping sequence, or simultaneously. Other techniques may be invented or discovered and applied, without departing from the present invention.

In one embodiment, the count of events that occur in a time interval are compared between reference day 1702 and present day 1704. Accordingly, ref day event counter 1726 and present-day event counter 1728 are utilized. In one embodiment, if a lack of usage events in a present-day 1704 time interval is less than expected, a search is extend to a larger interval of time, extending further back in time. For example, if few usage events are detected in an afternoon, morning event counts are also examined and compared.

In one embodiment, a count of usage events less than a reference in a single observation interval triggers a state of WARN concern, while a count less than expected for two or more consecutive observation intervals triggers a state of CRITICAL concern. The reference event count threshold may be one or more.

In another embodiment, the approximately 24 hours comprising a day are divided into sub-intervals for the purpose of monitoring utility usage events. For example, a day may be divided into four sub intervals, and referred to by labels such as NIGHT, MORNING, MIDDAY, AFTERNOON. The sub intervals may be of equal or differing lengths and may correspond to pre-determined times of day. In another embodiment, the intervals and their start and end times are adaptively adjusted according to usage patterns. In such an embodiment, the detection of usage is a binary filter—in each sub-interval a determination is made if there has been usage or no usage. Logic is then applied to the determinations to assess the health and well-being status. For example, a single sub-interval with no usage is a cause for moderate concern, while two consecutive sub-intervals with no usage is cause for even more concern.

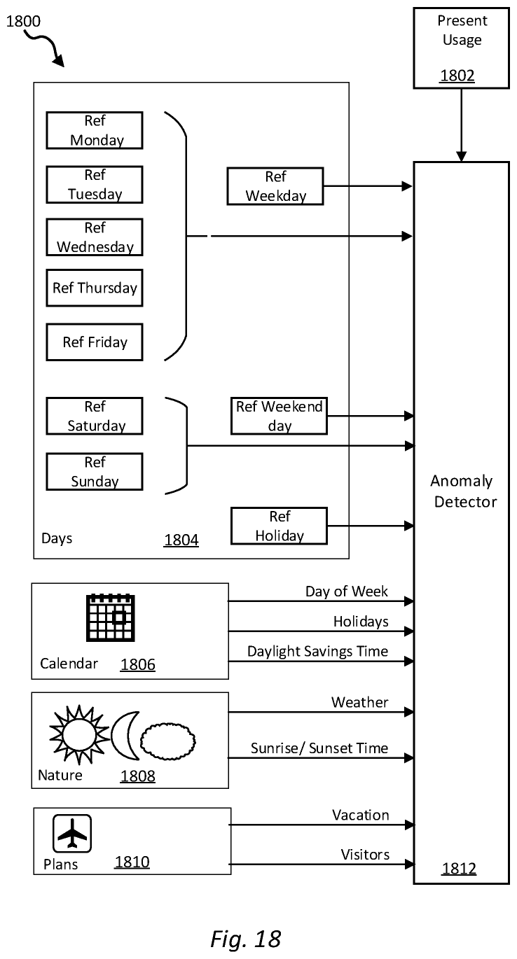

FIG. 18 depicts a schematic representation according to the present invention, for using enhanced awareness of the situation to determine if present usage patterns are anomalous. In system 1800, present day usage fingerprint 1802 is processed by anomaly detector 1812 to determine level of concern represented by present day utility usage. Anomaly detector 1812 takes as a reference several aspects as shown. A reference day fingerprint is selected from days stored or pre-programmed in 1804.

Natural factors 1808 such as sunrise and set times and weather are likely to influence utility usage so are considered. Calendar factors 1806 such as day-of-week, daylight savings time begin and end days, and holidays may affect patterns of life and thus utility usage and are also considered. Finally, disruptions to patterns of life due to visitors, vacations, or the like are considered from plans 1810.

Although the foregoing describes several techniques used to compare usage patterns and implement strategies to detect anomalies in embodiments of the invention, many other algorithms and pattern matching strategies are possible in other embodiments, all according to the invention and its description. For example, statistical analysis is known in the art as a technique to characterize data by various statistical measures, such as mean, median, standard deviation, density, derivatives, distribution and these measures may be applied to usage events in any time interval to compare and contrast usage during the interval with a reference. Similarly, techniques are known in the art for pattern matching and differentiation, including feature extraction, Bayesian analysis, maximum likelihood, clustering, discriminant functions, neural networks, and stochastic methods, and any or all are applied in embodiments consistent with the present invention.

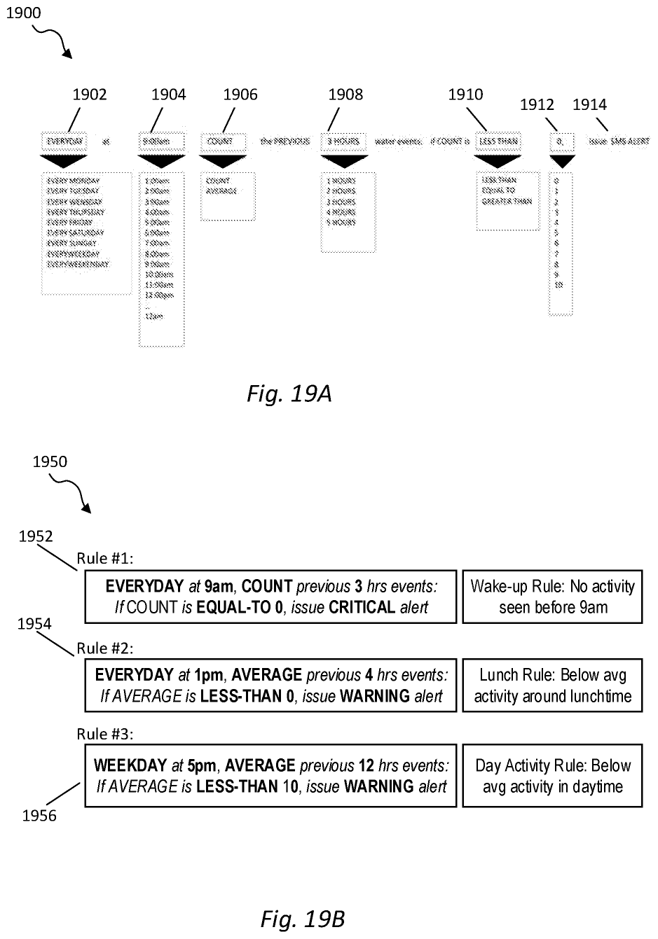

FIGS. 19A and 19B depict using an embodiment of a rule-based scheme to define a reference pattern for comparing present usage data and defining consequent actions. Rule template 1900 illustrates a syntax that creates a rule from a pre-defined number of pre-defined fields and pre-defined range values for each field. The rule contains antecedent matching criteria 1902, 1904, 1906, 1908. 1910, and 1912, and a consequent 1914 to be asserted if the antecedents are determined to be true.

The rule structure of rule template 1900 is only one of a number of rules and constrained fields that may be used as a reference pattern in accordance with the present invention. One or multiple rules may be used to define a reference day, event counts in intervals, consequent actions, or other reference tests.

Rule template 1900 defines a template that may be filled by several means in accordance with embodiments. In one embodiment, the rule is designed within the template by a human using an editor or similar rule editing tool. In another embodiment, the rule structure is used to capture observations or past behavior, automatically by examining data, without human intervention, but providing a human-readable means to understand the rules being applied as a reference in detecting anomalous usage or concern in well-being status of a monitored person.

In some embodiments, a rule is initially created by an automated process yet a human using a suitable editor has the ability to observe and possibly change the fields.

FIG. 19B further illustrates the concept of how in an embodiment, rule set 1950 is used as a reference in detection of usage anomalies and to define corresponding levels of concern and alert messages to be sent when a rule is triggered. Three rules 1952, 1954, and 1956 comprise rule set 1950.

In one embodiment an inference engine processes the rules in combination with facts about present usage, events, or usage patterns. Inference engines that process a set of rules against a set of asserted facts to produce conclusions are known in the art as forward-chaining or modus ponens systems. In alternative embodiments, the rule system is implemented as a fuzzy logic inference system, where numerical usage measures are automatically machine-characterized by a series of exclusively assigned labels or bins, for example a measured usage quantity in a time interval may be assigned as exactly one of “no usage,” “little usage,” “much usage,” or “excessive usage.” Rules then are defined using these labels as antecedents or in conditional expressions.

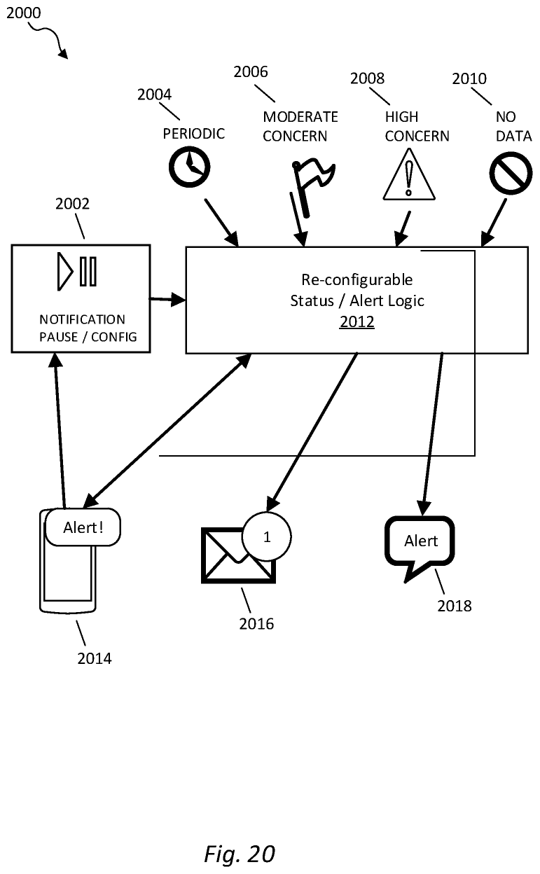

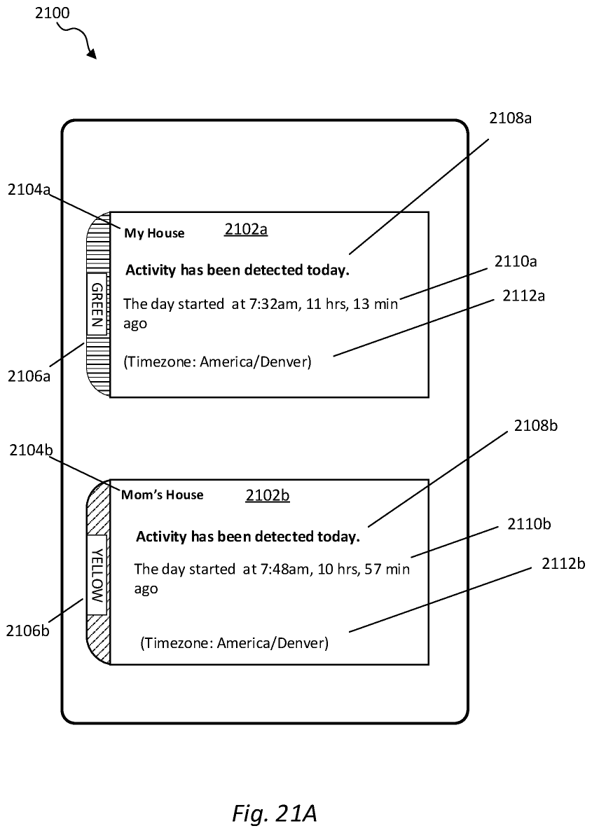

FIG. 20 schematically illustrates logic, inputs, and outputs that create a notification system in accord with the present invention. Alerting 2000 is centered on alerting and status logic 2012. Alerting and status logic 2012 takes as inputs a periodic request for update from Timer 2004, the status of the health monitoring algorithms, which may be either WARN LEVEL CONCERN 2006 or CRITICAL LEVEL CONCERN 2008—it may be either one, neither, but not both simultaneously. An input is also, in some embodiments, detection of loss of data from a sensor being monitored at data loss 2010. This may indicate an equipment failure, power outage or similar event that prevents data from being sent.

Alerting and status logic 2012 also considers notification pause/config 2002 which allows each user to configure which alerts are received and which triggers are observed or ignored. In one embodiment, ignoring a trigger or silencing an alarm is only allowed temporarily, analogous to silencing a nuisance alarm from a smoke detector without permanently disabling its warnings.

Also configurable is the type of warning and updates sent. Three representative types are shown for illustration. Device 2014 is a smart phone, tablet, or laptop that may receive messages such as SMS. In one embodiment, device 2014 is equipped with an application to handle alerts and status queries. At 2016, an email notification is shown. At 2018, an instant message Notification is shown, which may be useful with Slack or a similar Instant Messaging (IM) platform.

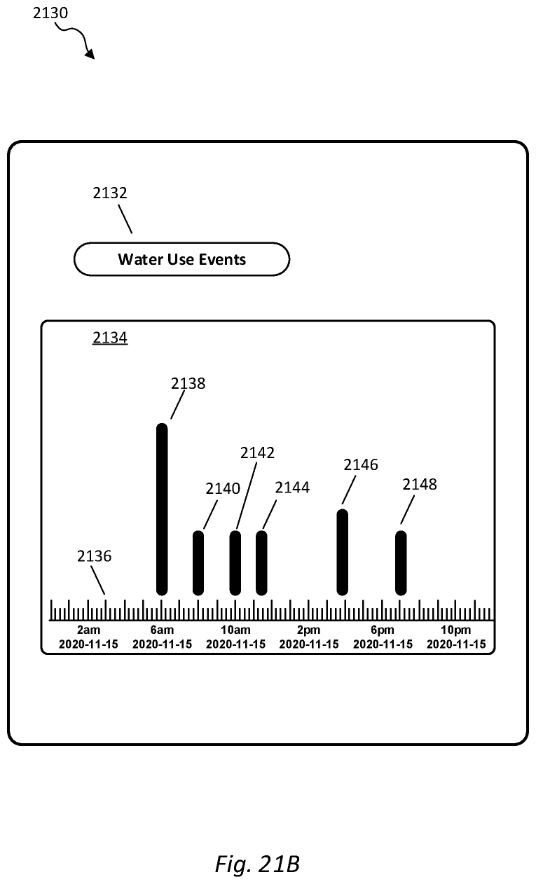

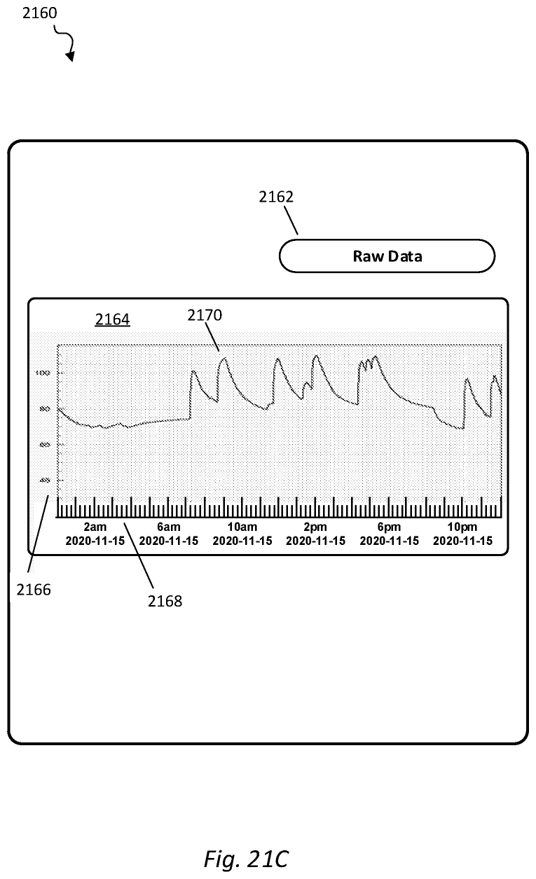

FIG. 21A, 21B, and 21C provide schematic depictions of data displays employed to show a user the present well-being status of a person being monitored, in embodiments. As noted previously, it should be kept in mind that the depictions in these figures are monochromatic for simplicity of illustration, yet in actual embodiments the full graphic capabilities of the display device, including multiple colors, colored regions, contrasting colors, and flashing or blinking, is deployed. In the figures, simple graphical representations such as shading and angled lines, in conjunction with color name labels e.g. “red” or “green” are shown but it should be appreciated that in actual embodiments, the regions would actually display a distinctive and informative color or sequence of colors.

It should also be appreciated that the displays depicted in FIGS. 21A, 21B, and 21C are, in various embodiments, displayed on a computer monitor, a tablet display, or a mobile phone and in those embodiments, are provided as part of an interactive user interface and application software appropriate for the device, display, and operating system. Those applications provide many user interface displays and menus that are familiar in the art, typically activated by gestures or menu selections, and many are omitted here to focus on the inventive aspects of displays in embodiments. In other words, the depicted screens are only a subset of many screens that are implemented in an actual application for example, to facilitate housekeeping, setup, billing, legal notices, and configuration preferences.

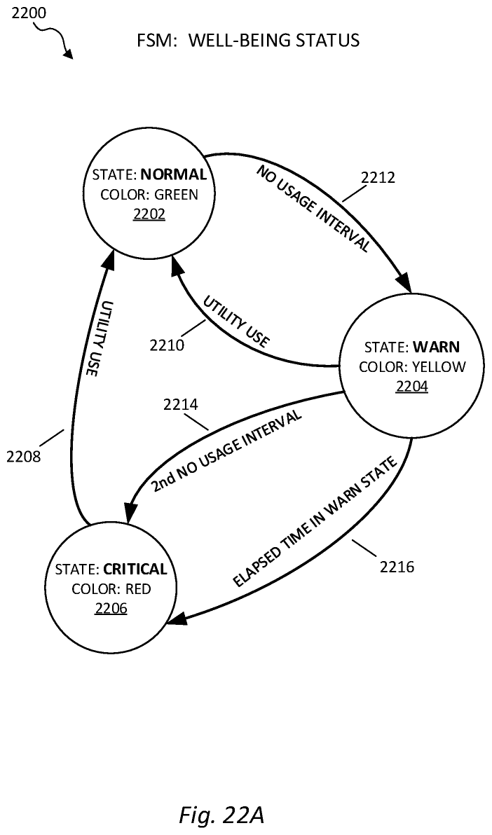

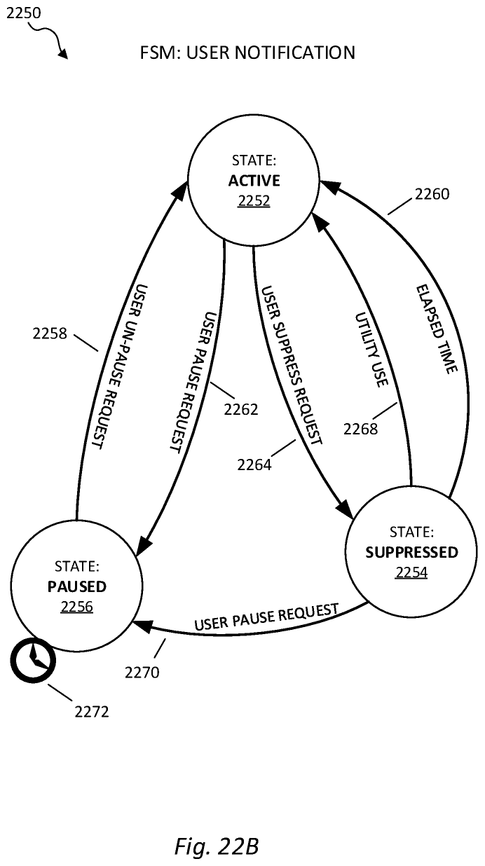

Referring to FIG. 21A, display window 2100 provides two display regions 2102. Each display region 2102 corresponds to a location and provides a user information about that location and the status of person being monitored at that location (refer to FIG. 12). Two locations are shown for simplicity, but many locations may be displayed; no limit should be inferred. In display region 2102, location label 2104 identifies the location that corresponds to the display region 2102 and the data displayed therein. Status bar 2106 displays the well-being status of the person being monitored at the location, and in one embodiment is filled with a color corresponding to the well-being status. For example, status bar 2106 being green indicates a NORMAL status, status bar 2106 being yellow indicates a WARNING status, and status bar 2106 being red indicates a CRITICAL status. Other assignments of colors or display patterns to correspond to status states are possible, for example flashing or alternating colors to draw attention, or audible alerts. The red/yellow/green scheme is readily known to most persons. These status conditions are further described in conjunction with FIG. 22A. It should be appreciated that there are many display conventions that may be employed to indicate well-being status to a user in various embodiments, all in accordance with the invention described herein. The invention does not rely on any specific graphical display, type, or display convention.

Status string 2108 indicates if activity by the person being monitored has been detected today, that is since midnight. Day start string 2110 indicates the time activity was first detected today and the time elapsed between that activity and the present time. Time zone string 2112 indicates the time zone corresponding to the location.

FIG. 21B depicts display window 2130 which provides a more detailed view of the activity at a location in the present day. Display label 2132 shows this display is showing water use events in the present day. Graphical display 2134, in one embodiment, depicts utility usage events in that have been detected in the present day. Time scale 2136 provides a timeline. It should be appreciated that timeline 2136 may be scaled to show events in any arbitrary interval of time, and in various embodiments, may be dynamically zoomed to display longer or shorter intervals, or to zoom in on intervals of interest.

Graphical display 2134 shows six utility usage events 2138, 2140, 2142, 2144, 2146, and 2148. The events correspond to actual measured usage and the events shown are illustrative only—actual measured usage may have more or less events, or none. Each usage event is shown, in this embodiment, as a bar where the length of the bar indicates the number of usage events that were detected in the time interval corresponding to the time-on-time axis 2136. There are many conventions for displaying usage events, start times, and durations, all in accordance with the present invention.

FIG. 21C depicts a raw data display window 2160. Display label 2162 shows the window is displaying raw data from a sensor at the corresponding location. Graphical display 2164 shows data sequence 2170 drawn relative to X axis 2168 and Y axis 2166. X axis 2168 is marked to indicate an interval of time and Y axis 2168 is marked to indicate a sensor value, where the units may be degrees (temperature), percent, or relative magnitude.

A salient feature of the embodiment illustrated in depictions in FIG. 21C is that the user is viewing the raw sensor data at the location, whereas in FIG. 21A and 21B the user is viewing data after automatic processing to detect events. This allows the user to observe both raw and processed data nearly simultaneously, and compare the raw data to the processed, which may be useful for troubleshooting, configuring the system, or to build confidence in the automatic capabilities for detecting events and well-being status. However, the raw data window display 2160 in FIG. 21C is completely non-essential for most users who need only rely on the automatic and pattern detection capabilities as displayed in window 2100 (FIG. 21A) and 2130 (FIG. 21B).

FIG. 22A and 22B diagrammatically depict a state machine model implemented to track well-being and alert status in embodiments of the invention. A state machine, also known as a finite state machine, or FSM, is a model of a system (or subsystem) design that is implemented in software, such that the system is implemented to be in exactly one of a pre-defined number of discrete states at any given time. The model defines the states, and also defines the conditions or events that cause the system to transition from its present state to another of the pre-determined states as time progresses. Time passage is implicit in an FSM definition in that the system is in one state at any instant in time and as time progresses may remain in the state or transition to another state. That is, all states and events that cause the system to change states, and the corresponding next states, are defined by a state machine model diagram.

FIG. 22A depicts an FSM model of system 2200 corresponding to the well-being status of the person being monitored, according to an embodiment of the invention. The well-being status is always one of three pre-defined states: NORMAL state 2202, WARN state 2204, or CRITICAL state 2206. NORMAL state 2203 is the starting state of the system 2200. System 2200 remains in NORMAL state 2202 until the event of no usage of utility during a pre-defined interval triggers transition 2212 to WARN state 2204. In one embodiment, the interval for usage detection divides a day into periods such as morning hours, midday hours, afternoon hours, and evening hours. In other words, no observed utility usage during one of these periods would trigger transition 2212 from NORMAL to WARN state 2204.

Still referring to FIG. 22A, and system 2200 being in WARN state 2204, system 2200 remains in WARN state 2204 unless one of three events triggers a transition. Any utility usage triggers transition 2210 and system 2200 enters the NORMAL state 2202. System 2200 transitions to CRITICAL state 2206 if there is no usage of utility during a second consecutive pre-defined interval, triggering transition 2214. System 2200 also transitions to CRITICAL state 2206 in the event a pre-defined time interval elapses with system 2200 dwelling in WARN state 2204, triggering transition 2216. For example, the pre-defined time interval triggering transition 2216 is in one embodiment, 30 minutes.

Once system 2200 is in CRITICAL state 2206, it remains there until any observed utility usage triggers transition 2208 to NORMAL state 2202. Implicit in most states (and not shown) is a timer that measures time in state. For example, in one embodiment a notification to the user is triggered periodically while in WARN state 2204 or CRITICAL state 2206, using the timer to measure the notification interval. Similarly, the intervals that trigger transition 2212 and 2214 require a time measurement.

Referring now to FIG. 22B, an FSM is depicted to model notification subsystem 2250. Although in many embodiments a primary purpose of the invention is to provide notification to the user of any cause for concern resulting from detection of utility usage patterns, anomalies, or lack of usage by a person being monitored, it is also often the case that a user wants to either temporarily suppress or indefinitely pause notifications. This may be the case for example, if a user knows the person being monitored is not at home or is on vacation so lack of utility usage is not a cause for concern and notifications would be an annoyance rather than useful.

Accordingly, and with reference to FIG. 22B according to an embodiment of the invention, notification subsystem 2250 is depicted as an FSM model with three discrete states: ACTIVE state 2252 passes all notifications to user, SUPPRESSED state 2254 silences notifications temporarily, and PAUSED state 2256 silences notifications until the user re-enables them. The initial and normal state is ACTIVE state 2252. Subsystem 2250 remains in ACTIVE state 2252 until a user requests a change. A user initiates transition 2264 to SUPPRESSED state 2254 or transition 2258 to PAUSED state 2256. Typically, these requests correspond to elements of the user interface.

It should be noted that labels used to describe states of FSM models herein are for convenience of reference only and have no effect on functionality or operation of the corresponding FSM. Because these state labels are, in some embodiments, used to indicate the present state of the system to a user or displayed on a screen, it is often convenient to use other labels that are more familiar to users, or to communicate to users speaking other languages, or to create one or more alias labels. For example, in one embodiment the state described in reference to FIG. 22B as SUPPRESSED is also described as SNOOZE, because users may be familiar with the snooze button typically found on an alarm clock, and the functionality is analogous. In one embodiment, state label aliases used in displays are based on a language preference setting, for example English, Spanish, Portuguese, or the like.

Referring to FIG. 22B, when subsystem 2250 is in SUPPRESSED state 2254, three events trigger a transition. User request for pause triggers transition 2270 to PAUSED state 2256. Observed utility usage triggers transition 2268 to ACTIVE state 2252. And passage of a predetermined interval of time triggers transition 2260 to ACTIVE state 2252.

The remaining PAUSED state 2256 persists until user requests triggering transition 2258 to ACTIVE state 2252. In one embodiment, timer 2272 initiates periodic reminder notices to the user that notification subsystem 2250 is paused, since PAUSED state 2272 prevents any notifications being sent to the user and could inadvertently cause a critical notice to be missed.

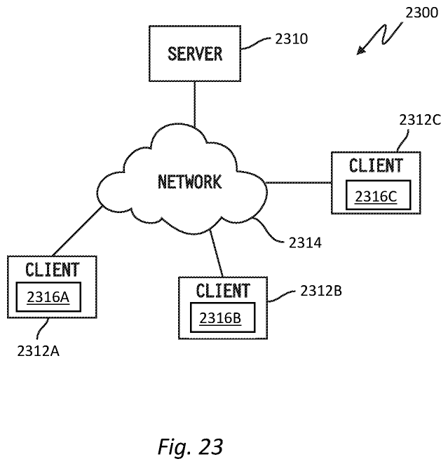

FIG. 23 is a schematic diagrammatic view of a network system in which embodiments of the present invention may be utilized. FIG. 23 is a high-level block diagram of a computing environment 2300 according to one embodiment. FIG. 23 illustrates server 2310 and three clients 2312 connected by network 2314. Only three clients 2312 are shown in FIG. 23 in order to simplify and clarify the description. Embodiments of the computing environment 2300 may have thousands or millions of clients 2312 connected to network 2314, for example the Internet. Users (not shown) may operate software 2316 on one of clients 2312 to both send and receive messages network 2314 via server 2310 and its associated communications equipment and software (not shown).

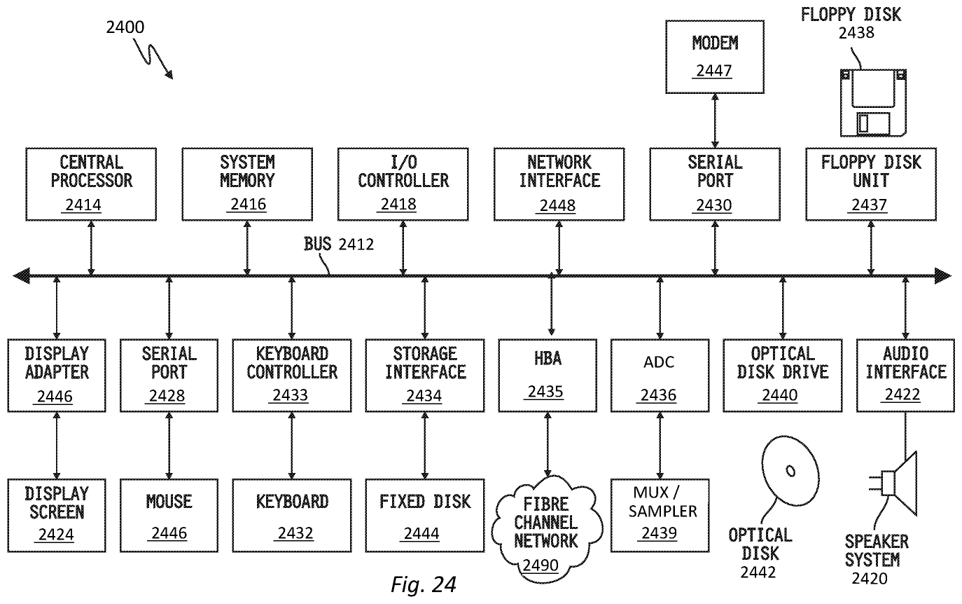

FIG. 24 depicts a block diagram of computer system 2400 suitable for implementing server 2310 or client 2312. Computer system 2400 includes bus 2412 which interconnects major subsystems of computer system 2400, such as central processor 2414, system memory 2416 (typically RAM, but which may also include ROM, flash RAM, or the like), input/output controller 2418, external audio device, such as speaker system 2420 via audio output interface 2422, external device, such as display screen 2424 via display adapter 2426, serial ports 2428 and 2430, keyboard 2432 (interfaced with keyboard controller 2433), storage interface 2434, disk drive 2437 operative to receive floppy disk 2438 (disk drive 2437 is used to represent various type of removable memory such as flash drives, memory sticks and the like), host bus adapter (HBA) interface card 2435 operative to connect with Fibre Channel network 2490, and optical disk drive 2240 operative to receive optical disk 2442. Analog to digital converter 2436, in signal connection with multiplexer and sampler 2439 is operative for the acquisition of analog signals and sampling and conversion of external time-varying voltages into numerical (digital) values and sequences of values on bus 2412 or stored in memory 2416. Also included are mouse 2446 (or other point-and-click device, coupled to bus 2412 via serial port 2428), modem 2447 (coupled to bus 2412 via serial port 2430), and network interface 2448 (coupled directly to bus 2412).

Bus 2412 allows data communication between central processor 2414 and system memory 2417, which may include read-only memory (ROM) or flash memory (neither shown), and random-access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 2410 are generally stored on and accessed via computer readable media, such as hard disk drives (e.g., fixed disk 2444), optical drives (e.g., optical drive 2440), floppy disk unit 2437, or other storage medium. Additionally, applications may be in the form of electronic signals modulated in accordance with the application and data communication technology when accessed via network modem 2447 or interface 2448 or other telecommunications equipment (not shown).

Storage interface 2434, as with other storage interfaces of computer system 2400, may connect to standard computer readable media for storage and/or retrieval of information, such as fixed disk drive 2444. Fixed disk drive 2444 may be part of computer system 2400 or may be separate and accessed through other interface systems. Modem 2447 may provide direct connection to remote servers via telephone link or the internet via an internet service provider (ISP) (not shown). Modem 2447 may also provide a data or encoded voice connection to a mobile telephone or PCS network. Network interface 2448 may provide direct connection to remote servers via network link to the internet, a local area network, a WiFi network, a Bluetooth network, a NFC (near field communication) network, an infrared data link, or the like. Network interface 2448 may provide such connection using wireless techniques, including digital cellular telephone connection, WiFi (IEEE 802.11), Bluetooth, PCS, 3G, 4G, 5G, Cellular Digital Packet Data (CDPD) connection, digital satellite data connection or the like. Many other devices or subsystems (not shown) may be connected in a similar manner (e.g., document scanners, digital cameras and so on). Conversely, all of the devices shown in FIG. 24 need not be present to practice the present disclosure. Devices and subsystems may be interconnected in different ways from that shown in FIG. 24.

Operation of a computer system such as that shown in FIG. 24 is readily known in the art and is not discussed in detail in this application. Software source and/or object codes to implement the present disclosure may be stored in computer-readable storage media such as one or more of system memory 2417, fixed disk 2444, optical disk 2442, or floppy disk 2438. The operating system provided on computer system 2400 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 2400 may take the form of a smart phone device, or tablet computer, typically in the form of a display screen operated by touching the screen, configured to respond to a variety of predetermined sensitive zones (buttons) and respond to predetermined finger touch gestures such as swipe, pinch, rotate or the like, performed with one or more fingers. In smart phone or tablet embodiments, the touch sensitive screen typically can be configured to operate to emulate the functions of a mouse/pointer device or keyboard input device for text or numerical entries. In smart phone or tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems. Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks.

Although the signals of the above-described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While one or more embodiments of this invention have been described as having an illustrative design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed:

1. A method of monitoring a residence for human activity, the residence having at least one utility capable of being activated by human activity, the method including the steps of:
providing a signal generating device;
providing a utility activation sensing device;
enabling the signal generating device to send a signal when the utility activation sensing device indicates the at least one utility has been activated.

2. The method of claim 1 wherein the signal generating device sends a signal indicative of the utility that has been activated.

3. The method of claim 1 wherein the signal generating device is connected to a network and sends the signal over the network.

4. The method of claim 1 wherein the utility activation sensing device includes an electricity sensor.

5. The method of claim 4 wherein the electricity sensor monitors a subset of the electric utility consumption of the residence.

6. The method of claim 1 wherein the utility activation sensing device includes a water flow sensor.

7. The method of claim 6 wherein the water flow sensor monitors a subset of the water consumption of the residence.

8. The method of claim 6 wherein the water flow sensor monitors a hot water circuit of the residential water system.

9. The method of claim 6 wherein the water flow sensor monitors a sewage line of the residence.

10. A system for determining health and well-being of a human person in a residence, the residence having at least one utility, the system comprising:
a sensor for detecting usage of the at least one utility;
a timer having interval measurement, rate measurement, and calendar time measurement;
storage coupled to the sensor and timer for storing sensor data and timer measurements;
a processor device in communication with the sensor, the storage, and the timer, the processor configured to determine a reference pattern based on the sensor data and timer measurements of the storage, the processor further configured to compare in near real-time, sensed present utility usage patterns over time to a reference pattern, and to alert when an anomaly is detected; and
a communications module configured to enable the processor to send information relating to a detected anomaly.

11. The system of claim 10 wherein the sensor is configured to detect flow of hot water in the residence.

12. The system of claim 10 wherein the residence has a hot water heating device, and the sensor is located at an exit of the hot water heating device.

13. The system of claim 10 wherein the residence is coupled in a utility network with other residences, and the sensor is located within the utility network in a location where the other residences do not consume the utility resource.

14. The system of claim 10 wherein the sensor detects a rate of change of temperature of a hot water pipe in the residence.

15. The system of claim 14 wherein a rate of change of about 5 degrees F. over about 120 seconds is taken as a threshold indicating a start of change of water flow rate.

16. The system of claim 10 wherein usage events are based on detecting patterns or features in the stored history of sensed data and correlating time of features.

17. The system of claim 14 wherein usage events are determined by monitoring a rate of temperature change in the water pipe, and when the monitored temperature change in a first direction exceeds a threshold value then monitoring the time duration of the temperature change until the rate of temperature change in the water pipe exceeds a threshold value in a second direction opposite the first direction.

18. A method for detecting human activity in a multi-residence facility having a residential utility delivery network, the method steps comprising:
installing, at a location within a residential utility delivery network, a sensor configured to detect flow of the utility through the network;
sensing activity of the utility;
recording a time duration of sensed utility activity;
comparing recorded activity duration patterns to a reference pattern;
applying pattern matching logic to determine if the sensed utility activity differs from the reference pattern;
sending a message relating to an inference of human activity of a person in the residence and using recorded activity duration patterns.

19. The method of claim 18 further comprising the step of installing a second utility sensor at other location within one of the residential utility delivery network or in a second utility network within residence facility.

20. The method of claim 18 wherein the recorded utility duration patterns are additionally used to infer health and well-being status of at least one person in the residence facility.
